(19) United States
(12) Patent Application Publication
(10) Pub. No.: US 2004/0196282 A1
(43) Pub. Date: Oct. 7, 2004

(54) Modeling and editing image panoramas

(76) Inventor: Byong Mok Oh, Newton, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/780,500

(22) Filed: Feb. 17, 2004

Related U.S. Application Data
(60) Provisional application No. 60/447,652, filed on Feb. 14, 2003.

(51) Int. Cl. G06T 15/00

(52) U.S. Cl. 345/419

(57) ABSTRACT

Three-dimensional models are created from one or more image panoramas. One or more image panoramas representing a visual scene and having one or more objects is received. A directional vector for each image panorama is determined, the directional vector indicating an orientation of the visual scene with respect to a reference coordinate system. The image panoramas are transformed such that the directional vectors are aligned relative to the reference coordinate system. The transformed image panoramas are aligned to each other. A three dimensional model of the visual scene is created using the reference coordinate system, the model comprising depth information describing the one or more objects contained in the scene.

### CROSS-REFERENCE TO RELATED APPLICATIONS

This application claims the benefit of U.S. Provisional Application No. 60/447,652, entitled “Photorealistic 3D Content Creation and Editing From Generalized Panoramic Image Data,” filed Feb. 14, 2003.

### FIELD OF INVENTION

The invention relates generally to computer graphics. More specifically, the invention relates to a system and methods for creating and editing three-dimensional models from image panoramas.

### BACKGROUND

One objective in the field of computer graphics is to create realistic images of three-dimensional environments using a computer. These images and the models used to generate them have an incredible variety of applications, from movies, games, and other entertainment applications, to architecture, city planning, design, teaching, medicine, and many others.

Traditional techniques in computer graphics attempt to create realistic scenes using geometric modeling, reflection and material modeling, light transport simulation, and perceptual modeling. Despite the tremendous advances that have been made in these areas in recent years, such computer modeling techniques are not able to create convincing photorealistic images of real and complex scenes.

An alternate approach, known as image-based modeling and rendering (IBMR) is becoming increasingly popular, both in computer vision and graphics. IBMR techniques focus on the creation of three-dimensional rendered scenes starting from photographs of the real world. Often, to capture a continuous scene (e.g., an entire room, a large landscape, or a complex architectural scene) multiple photographs, taken from various viewpoints can be stitched together to create an image panorama. The scene can then be viewed from various directions, but cannot move in space, since there is no geometric information.

Existing IBMR techniques have focused on the problems of modeling and rendering captured scenes from photographs, while little attention has been given to the problems of interactively creating and editing image-based representations and objects within the images. While numerous software packages (such as ADOBE PHOTOSHOP, by Adobe Systems Incorporated, of San Jose, Calif.) provide photo-editing capabilities, none of these packages adequately addresses the problems of interactively creating or editing image-based representations of three-dimensional scenes including objects using panoramic images as input.

What is needed is editing software that includes familiar photo-editing tools adapted to create and edit an image-based representation of a three-dimensional scene captured using panoramic images.

### SUMMARY OF THE INVENTION

The invention provides a variety of tools and techniques for authoring photorealistic three-dimensional models by adding geometry information to panoramic photographic images, and for editing and manipulating panoramic images that include geometry information. The geometry information can be interactively created, edited, and viewed on a display of a computer system, while the corresponding pixel-level depth information used to render the information is stored in a database. The storing of the geometry information to the database is done in two different representations: vector-based and pixel-based. Vector-based geometry stores the vertices and triangle geometry information in three-dimensional space, while pixel-based representation stores the geometry as a depth map. A depth map is similar to a texture map, however it stores the distance from the camera position (i.e. the point of acquisition of the image) instead of color information. Because each data representation can be converted to the other, the terms pixel-based and vector-based geometry are used synonymously.

The software tools for working with such images include tools for specifying a reference coordinate system that describes a point of reference for modeling and editing, aligning certain features of image panoramas to the reference coordinate system, “extruding” elements of the image from the aligned features for using vector-based geometric primitives such as triangles and other three-dimensional shapes to define pixel-based depth in a two-dimensional image, and tools for “clone brushing” portions of an image with depth information while taking the depth information and lighting into account when copying from one portion of the image to another. The tools also include re-lighting tools that separate illumination information from texture information.

This invention relates to extending image-based modeling techniques discussed above, and combining them with novel graphical editing techniques to produce and edit photorealistic three-dimensional computer graphics models from generalized panoramic image data. Preferably, the present invention comprises one or more tools useful with a computing device having a graphical user interface to facilitate interaction with one or more images, represented as image data, as described below. In general, the systems and methods of the invention display results quickly, for use in interactively modeling and editing a three dimensional scene using one or more image panoramas as input.

In one aspect, the invention provides a computerized method for creating a three dimensional model from one or more panoramas. The method includes steps of receiving one or more image panoramas representing a scene having one or more objects, determining a directional vector for each image panorama that indicates an orientation of the scene with respect to a reference coordinate system, transforming the image panoramas such that the directional vectors are substantially aligned with the reference coordinate system, aligning the transformed image panoramas to each other, and creating a three dimensional model of the scene from the transformed image panoramas using the reference coordinate system and comprising depth information describing the geometry of one or more objects contained in the scene. Thus, objects in the scene can be edited and manipulated from an interactive viewpoint, but the visual representations of the edits will remain consistent with the reference coordinate system.

In some embodiments, the determination of a directional vector is based at least in part on instructions received from a user of the computerized method. In some embodiments, the instructions identify two or more visual features in the image panorama that are substantially parallel. In some embodiments, the instructions identify two sets of substantially parallel features in the image panorama. In some embodiments, the instructions identify and manipulate a horizon line of the image panorama. In some embodiments, the instructions identify two or more areas within the image that contain one or more elements, and automatically identifying the elements contained in the areas. In some embodiments, the automatic detection can be done using techniques such as edge detection and image processing techniques. In some embodiments, the image panoramas are aligned with respect to each other according to instructions from a user.

In some embodiments, the panorama transformation step includes aligning the directional vectors such that they are at least substantially parallel to the reference coordinate system. In some embodiments, the transformation step includes aligning the directional vectors such that they are at least substantially orthogonal to the reference coordinate system.

In another aspect, the invention provides a computerized method of interactively editing objects in a panoramic image. The method includes the steps of receiving an image panorama with a defined point source, creating a three-dimensional model of the scene using features of the visual scene and the point source, receiving an edit to an object in the image panorama, transforming the edit relative to a viewpoint defined by the point source, and projecting the transformed edit onto the object.

In some embodiments, the three-dimensional model includes either depth information, geometry information, or in some embodiments, both. In some embodiments, receiving an edit includes receiving an edit to the color information associated with objects of the image, or to the alpha (i.e., transparency) information associated with objects of the image. In some embodiments, receiving an edit includes receiving an edit to the depth or geometry information associated with objects of the image. In these embodiments, the method may include providing a user with one or more interactive drawing tools or interactive modeling tools for specifying edits to the depth and geometry information, color and texture information of objects in the image. The interactive tools can be one or more of an extrusion tool, a ground plane tool, a depth chisel tool, and a non-uniform rational B-spline tool. In some embodiments, the interactive drawing and geometric modeling tools select a value or values for the depth of an object of the image. In some embodiments the interactive depth editing tools add to or subtract from the depth for an object of the image.

In another aspect, the invention provides a method for projecting texture information onto a geometric feature within an image panorama. The method includes receiving instructions from a user identifying a three-dimensional geometric surface within an image panorama having features with one or more textures; determining a directional vector for the geometric surface, creating a geometric model of the image panorama based at least in part on the surface and the directional vector, and applying the textures to the features in the image panorama based on the geometric model.

In some embodiments, the instructions are received using an interactive drawing tool. In some embodiments, the geometric surface is one of a wall, a floor, or a ceiling. In some embodiments, the directional vector is substantially orthogonal to the surface. In some embodiments, the texture information comprises color information, and in some embodiments the texture information comprises luminance information.

In another aspect, the invention provides a method for creating a three-dimensional model of a visual scene from a set of image panoramas. The method includes receiving multiple image panoramas, arranging each image panorama to a common reference system, receiving information identifying features common to two or more of the arranged panoramas, aligning to two or more image panoramas to each other using the identified features, and creating a three-dimensional model from the aligned image panoramas.

In some embodiments, the instructions are received using an interactive drawing tool, which in some embodiments is used to identify four or more features common to the two or more image panoramas.

In another aspect, the invention provides a system for creating a three-dimensional model from one or more image panoramas. The system includes a means for receiving one or more image panoramas representing a visual scene having one or more objects, a means for allowing a user to interactively determine a directional vector for each image panorama, a means for aligning the image panoramas relatively to each other, and a means for creating a three-dimensional model from the aligned panoramas.

In some embodiments, the input images comprise two-dimensional images, and in some embodiments, the input images comprise three-dimensional images including one or more of depth information and geometry information. In some embodiments, the image panoramas are globally aligned with respect to each other.

In another aspect, the invention provides a system for interactively editing objects in a panoramic image. The system includes a receiver for receiving one or more image panoramas, where the image panoramas represent a visual scene and have one or more objects and a point source. The system further includes a modeling module for creating a three-dimensional model of the visual scene such that the model includes depth information describing the objects, one or more interactive editing tools for providing an edit to the objects, a transformation module for transforming the edit to a viewpoint defined by the point source, and a rendering module for projecting the transformed edit onto the objects.

In some embodiments, the interactive editing tools include a ground plane tool, an extrusion tool, a depth chisel tool, and anon-uniform rational B-spline tool.

### BRIEF DESCRIPTION OF THE DRAWINGS

The above and further advantages of the invention may be better understood by referring to the following description taken in conjunction with the accompanying drawings, in which:

FIG. 1 is a flowchart of an embodiment of a method in accordance with one embodiment of the invention.

FIG. 2 is a diagram illustrating a camera positioned within a room for taking panoramic photographs in accordance with one embodiment of the invention.

FIG. 3 is a diagram of a global reference coordinate system in accordance with one embodiment of the invention.

FIG. 4 is a diagram displaying the global coordinate system of FIG. 3 projected onto the room of FIG. 2 in accordance with one embodiment of the invention.

FIG. 5 is a diagram illustrating an image panorama in accordance with one embodiment of the invention.

FIG. 6a is a diagram illustrating a cube panorama in accordance with one embodiment of the invention.

FIG. 6b is a diagram illustrating a cube panorama in accordance with one embodiment of the invention.

FIG. 6c is a diagram illustrating a sphere panorama in accordance with one embodiment of the invention.

FIG. 7a is a diagram illustrating a camera positioned within a room for taking panoramic photographs in accordance with one embodiment of the invention.

FIG. 7b is a diagram illustrating a spherical image panorama representation of the room of FIG. 7a in accordance with one embodiment of the invention.

FIG. 8a is a diagram illustrating the local alignment of a panorama in accordance with one embodiment of the invention.

FIG. 8b is a photograph with features identified illustrating the local alignment of a panorama in accordance with one embodiment of the invention.

FIG. 9a is a diagram illustrating the spherical image panorama of FIG. 7b aligned with the global reference coordinates of FIG. 3 in accordance with one embodiment of the invention.

FIG. 9b is the photograph of FIG. 8b after local alignment in accordance with one embodiment of the invention.

FIG. 10 is a photograph with sets of parallel lines identified for local alignment in accordance with one embodiment of the invention.

FIGS. 11a, 11b, and 11c are diagrams illustrating local alignment with two sets of parallel lines in accordance with one embodiment of the invention.

FIG. 12 is a photograph with a horizon line identified for local alignment in accordance with one embodiment of the invention.

FIG. 13 is a diagram illustrating local alignment using a horizon line in accordance with one embodiment of the invention. FIGS. 14a and 14b are two panoramas to be used in creating a three-dimensional model in accordance with one embodiment of the invention.

FIGS. 15a and 15b are images being edited to create a three-dimensional model in accordance with one embodiment of the invention.

FIGS. 16a, 16b, and 16c are diagrams illustrating the global alignment process in accordance with one embodiment of the invention.

FIGS. 17a, 17b, and 17c are diagrams illustrating the global alignment process in accordance with one embodiment of the invention.

FIGS. 18a, 18b, and 18c are diagrams illustrating the global alignment process in accordance with one embodiment of the invention.

FIG. 19 is a diagram illustrating the global alignment process in accordance with one embodiment of the invention.

FIG. 20 is another diagram illustrating the translation step of the global alignment process in accordance with one embodiment of the invention.

FIG. 21 is an image representing a three-dimensional model of a scene created in accordance with one embodiment of the invention.

FIGS. 22a, 22b, and 22c are diagrams illustrating the positioning of a reference plane in accordance with one embodiment of the invention.

FIG. 23 is a diagram illustrating moving a reference plane to another location within a plane in accordance with one embodiment of the invention.

FIG. 24 is a diagram illustrating moving a reference plane to another location within a plane in accordance with one embodiment of the invention.

FIG. 25 is a diagram and photograph illustrating snapping a reference plane onto a geometry in accordance with one embodiment of the invention.

FIGS. 26a and 26b are diagrams illustrating the rotation of a reference plane in accordance with one embodiment of the invention.

FIGS. 27a and 27b are diagrams illustrating locating a reference plane based on the selection of points in a plane in accordance with one embodiment of the invention.

FIGS. 28a, 28b, and 28c are diagrams of a screen view, two-dimensional top view, and three-dimensional view respectively illustrating the use of an interactive ground-plane tool to extrude depth information in accordance with one embodiment of the invention.

FIGS. 29a, 29b, and 29c are diagrams of a screen view, two-dimensional top view, and three-dimensional view respectively illustrating further use of an interactive ground-plane tool to extrude depth information in accordance with one embodiment of the invention.

FIGS. 30a, 30b, and 30c are diagrams of a screen view, two-dimensional top view, and three-dimensional view respectively illustrating further use of an interactive ground-plane tool to extrude depth information in accordance with one embodiment of the invention.

FIGS. 31a, 31b, and 31c are diagrams of a screen view, two-dimensional top view, and three-dimensional view respectively illustrating further use of an interactive ground-plane tool to extrude depth information in accordance with one embodiment of the invention.

FIGS. 32a, 32b, and 32c are diagrams of a screen view, two-dimensional top view, and three-dimensional view respectively illustrating the use of an interactive vertical tool to extrude depth information in accordance with one embodiment of the invention.

FIGS. 33a, 33b, and 33c are diagrams illustrating a screen view, two-dimensional top view, and three-dimensional view respectively of a modeled room in accordance with one embodiment of the invention.

FIGS. 34a, 34b, and 34c are diagrams illustrating three-dimensional views and a screen view of a modeled image panorama in accordance with one embodiment of the invention.

FIG. 35 is a photograph of a hallway used as input to the methods and systems described herein in accordance with one embodiment of the invention.

FIG. 36 is a geometric representation of the photograph of FIG. 35 including a ground reference in accordance with one embodiment of the invention.

FIG. 37 is the photograph of FIG. 35 with the ground reference of FIG. 36 rotated onto the wall in accordance with one embodiment of the invention.

FIG. 38 is a geometric representation of the photograph and reference of FIG. 37 in accordance with one embodiment of the invention.

FIG. 39 is a geometric representation of the photograph and reference of FIG. 37 with an additional geometric feature defined, in accordance with one embodiment of the invention.

FIG. 40 is the photograph of FIG. 37 with the edit of FIG. 39 applied in accordance with one embodiment of the invention.

FIGS. 41a, 41b, and 41c are images illustrating texture mapping in accordance with one embodiment of the invention.

FIG. 42 is a diagram of a system for modeling and editing three-dimensional scenes in accordance with one embodiment of the invention.

### DETAILED DESCRIPTION

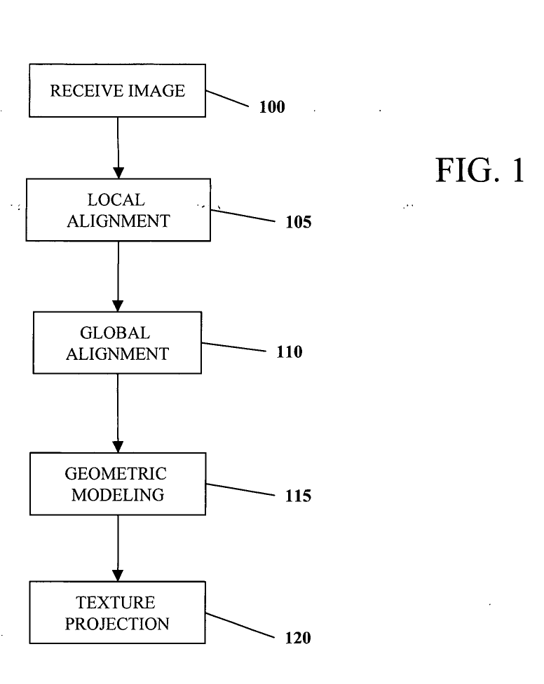

FIG. 1 illustrates a method for creating a three-dimensional (3D) model from one or more inputted two-dimensional (2D) image panoramas (the “original panorama”) in accordance with the invention. The original panorama, as described herein, can be one image panorama, or in some embodiments, multiple image panoramas representing a visual scene. The original panorama can be any one of various types of panoramas, such as a cube panorama, a sphere panorama, and a conical panorama. In one embodiment, the process includes receiving an image (STEP 100), aligning the image to a local reference (STEP 105), globally aligning multiple images (110), determining a geometric model of the scene represented by the images (STEP 115), and projecting texture information from the model onto objects within the scene (STEP 120).

The receiving step 100 includes receiving the original panorama. Alternatively, the computer system can accept for editing a 3D panoramic image that already has some geometric or depth information. 3D images represent a three-dimensional scene, and may include three-dimensional objects, but may be displayed to a user as a 2D image on, for example, a computer monitor. Such images may be acquired from a variety of laser, optical, or other depth measuring techniques for a given field of view. The image may be input by way of a scanner, electronic transfer, via a computer-attached digital camera, or other suitable input mechanism. The image can be stored in one or more memory devices, including local ROM or RAM, which can be permanent to or removable from a computer. In some embodiments, the image can be stored remotely and manipulated over a communications link such as a local or wide area network, an intranet, or the Internet using wired, wireless, or any combination of connection protocols.

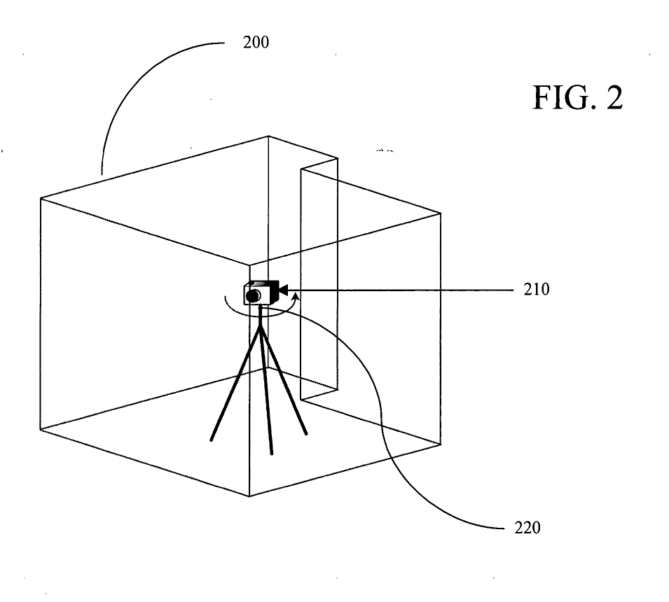

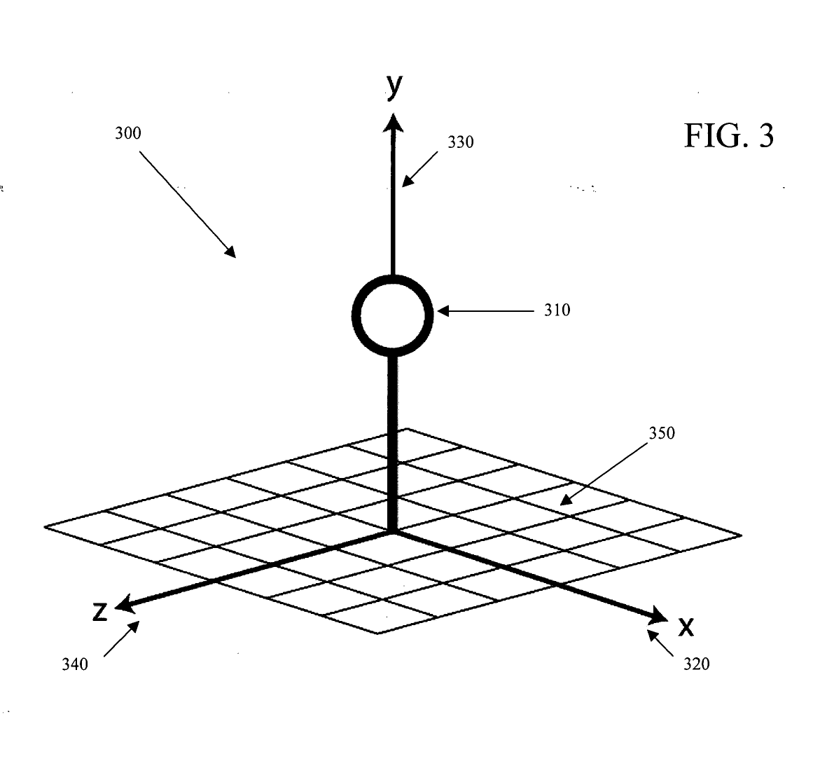

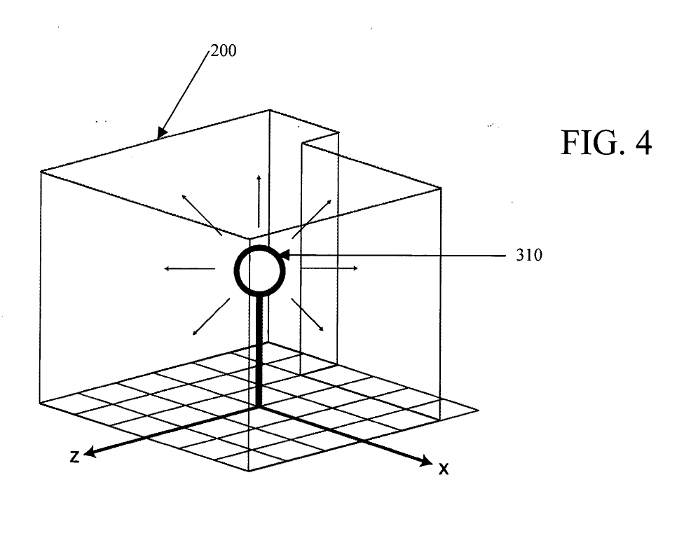

FIGS. 2-7 illustrate one process by which an image panorama may be captured using a camera. Referring to FIG. 2, a scene such as a room 200 is photographed using a camera 210 fixed at a position 220 within the room 200. The camera 210 can be rotated about the fixed position 220, pitched upwards or downwards, or in some cases yawed from side to side in order to capture the features of the scene. Referring to FIG. 3, a global reference coordinate system (“global reference”) 300 is defined as having three axes and a default reference ground plane. The x axis 320 defines the horizontal direction (left to right) as the scene is viewed by a user on a display device such as a computer screen. They axis 330 defines the vertical direction (up and down), and the z axis 340 defines depth within the image. The intersection of the x and y axes create a default reference plane 350, and a point source 310 is defined such that the it is located on the y axis, and represents the camera position from which the image panoramas were taken. In one embodiment, the point source is defined to be located at the point {0, 1, 0}, such that the point source is located on the y axis, one unit above the default reference plane 350. Other methods of defining the global reference 300 may be used, as the units and arrangement of the coordinates are not central to the invention. Referring to FIG. 4, the global reference is projected into the image such that the point source 310 is located at the camera position from which the images were taken, and the default reference plane 350 is aligned to the floor of the room 200.

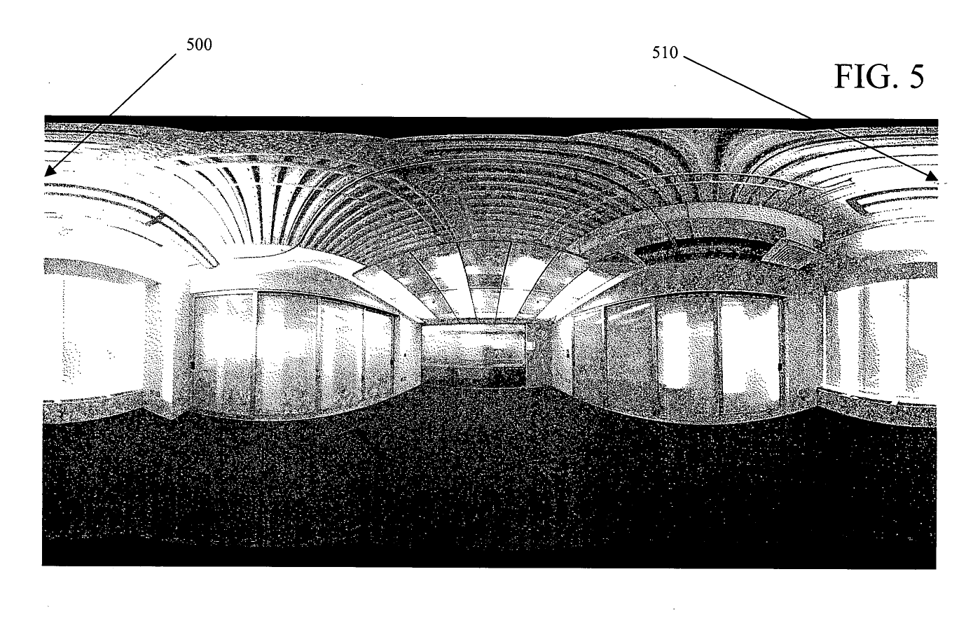

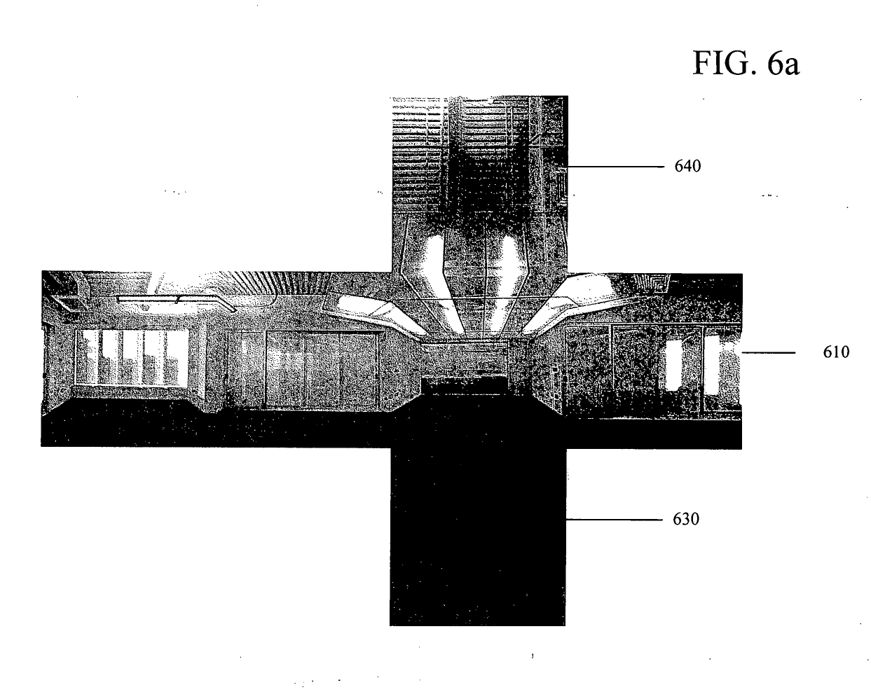

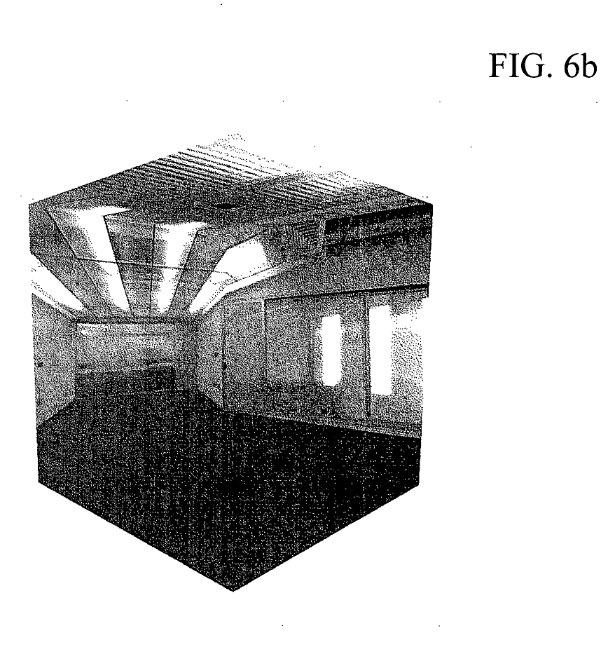

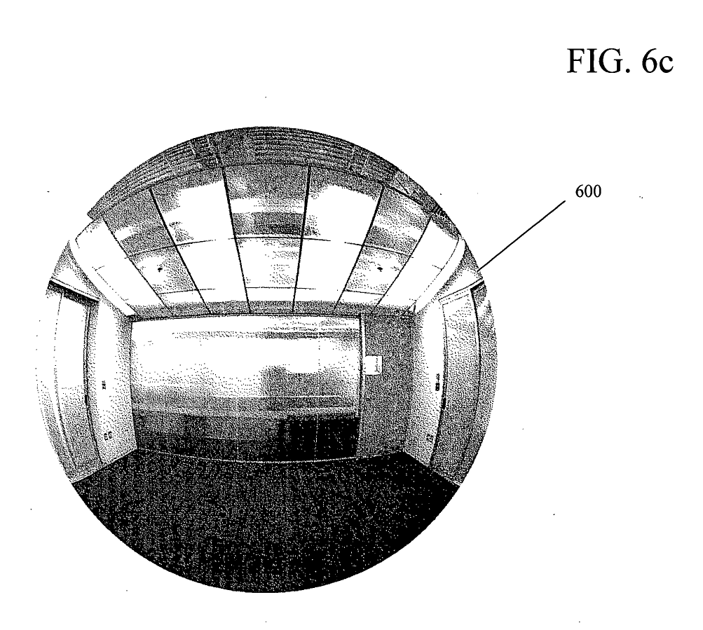

FIG. 5 illustrates an image panorama taken in the manner described above. The image, although presented in two dimensions, represents a complete spatial scene, whereby the points 500 and 510 represent the same physical location in the room. In some embodiments, the image depicted at FIG. 5 can be deconstructed into a “cube” panorama, as shown at FIGS. 6a and 6b. The lengthwise section 610 of the at FIG. 6a represents the four walls of the room, whereas the single square image 640 over the lengthwise section 610 represents the ceiling, and the single square image 630 below the lengthwise section 610 represents the floor. FIG. 6b illustrates the cube panorama with the individual images “folded” together such that the edges representing corresponding points in the image are placed together.

Other panorama types such as spherical panoramas or conical panoramas can also be used in accordance with the methods and systems of this invention. For example, FIG. 6c illustrates a spherical panorama, whereby the various photographs are stitched together to form a sphere such that every point in the room 200 appears to be equidistant from the point source 310.

Referring again to FIG. 1, the local alignment step 105 includes determining an “up” vector for the image panorama. Features known to the user to be vertical such as walls, window and door frames, or sides of buildings may not appear vertical in the image due to the camera position, warping during the stitching process, or other effects due to the three-dimensional scene being presented in two dimensions. Therefore, determining an “up” vector for the image allows the image to be aligned with the y axis of the global reference 300. In one embodiment, the “up” vector is determined using user-identified features of the image that have some spatial relationship to each other. For example, a user may define a line by indicating the start point and end point of the line that represents an feature of the image known to be either substantially vertical, substantially horizontal, or known by the user to have some other orientation to the global reference coordinates. The system can then use the identified features to computer the “up” vector for the image.

In one embodiment, the features designated by the user generally may comprise any two architectural features, decorative features, or other elements of the image that are substantially parallel to each other. Examples include, but are not necessarily limited to the intersection line of two walls, the sides of columns, edges of windows, lines on wallpaper, edges of wall hangings, or, in the case of outdoor scenes, trees or buildings. Alternatively, in some embodiments, the detection of the elements used for the local alignment step 205 may be done automatically. For example, a user may specify a region or regions that may or may not contain elements to be used for local alignment, and elements are identified using image processing techniques such as snapping, Gaussian edge detection, and other filtering and detection techniques.

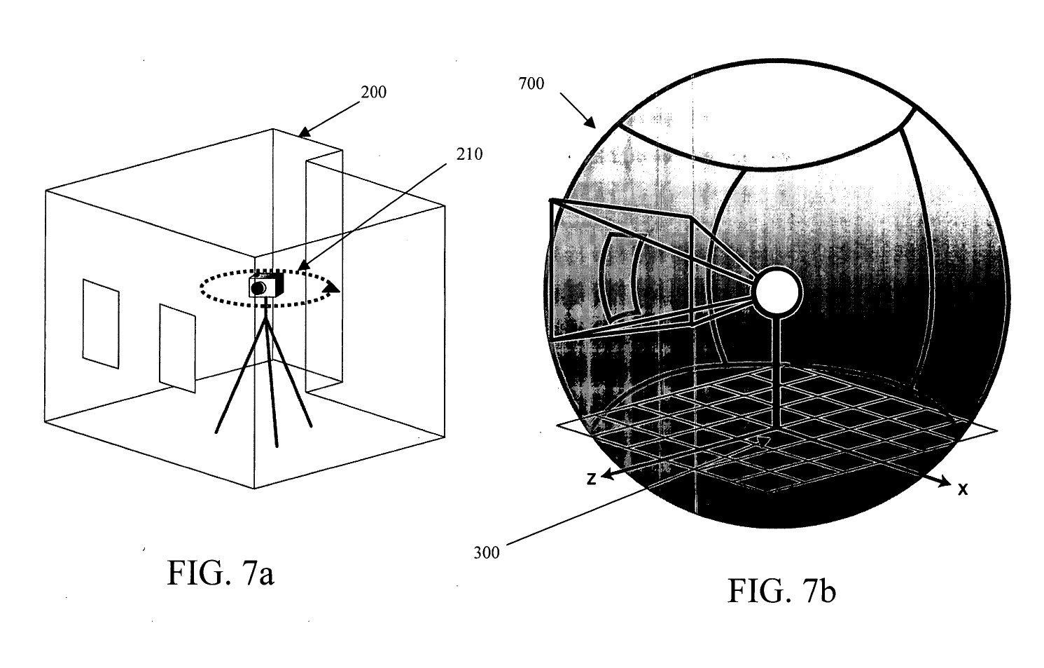

FIGS. 7a and 7b illustrate one embodiment of the manner in which an image panorama of the room 200 is represented to the user as a spherical panorama. The user, typically using a tripod, takes a series of photographs from a single position while rotating the camera 210 to a full 360 degrees, as shown in FIG. 7a. From one photograph to another, a significant amount of visible and overlapping features may be captured. During the stitching process, the user identifies points or lines from one photograph to another that are common in both photographs. This process can be done manually for all overlapping parts of the acquired photographs in order to create the image panorama. The user may also provide the stitching program with the type of lens used to acquire the scene, e.g. rectilinear lens or fisheye, wide-angle or zoom lens, etc. From this information, the stitching program can optimize the matches among the corresponding features, while minimizing the difference error. The output of a stitching program is illustrated, for example, in FIGS. 5, 6a, 6b, and 6c. A panorama viewer can be used to interactively view the image panorama with a specified view frustum.

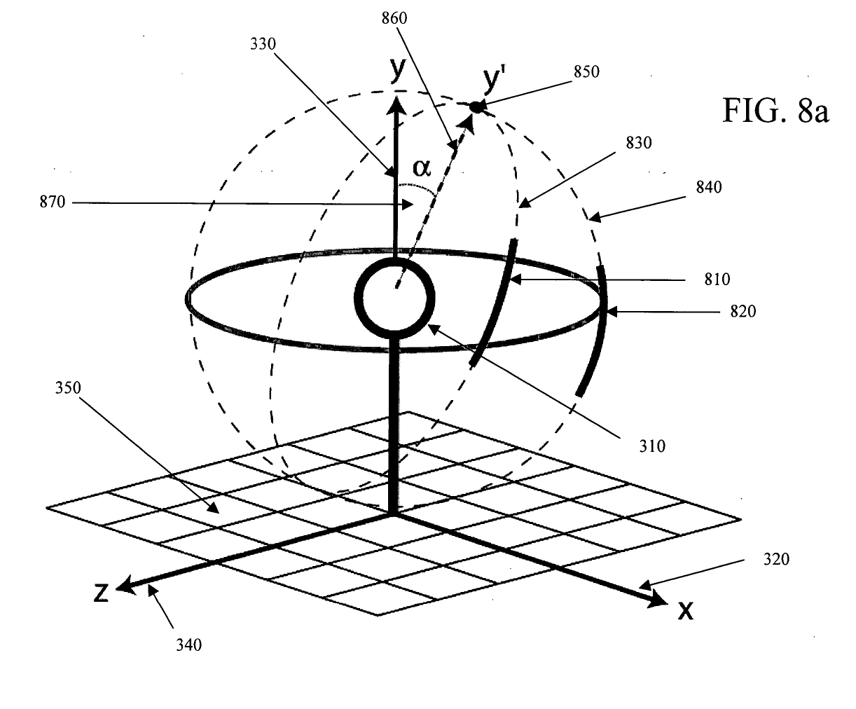

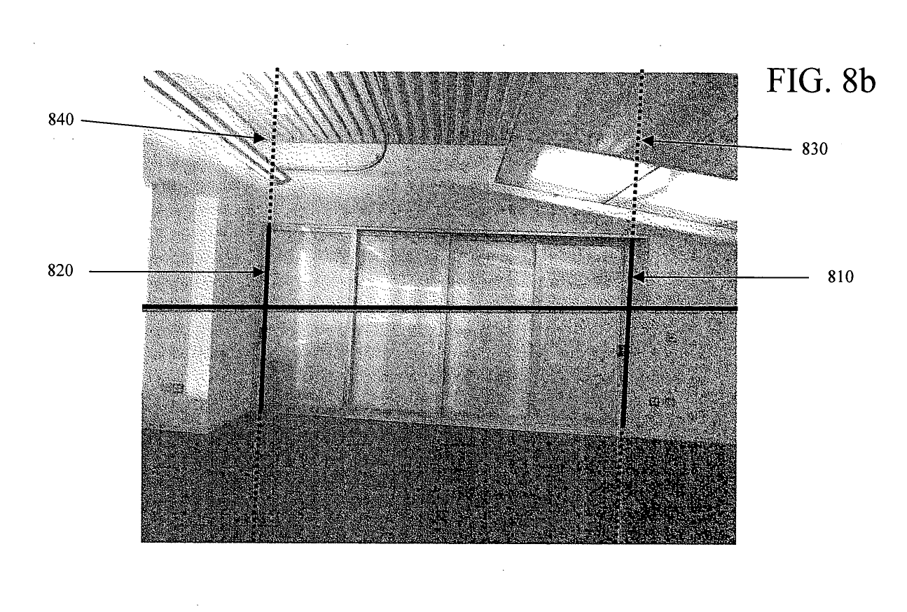

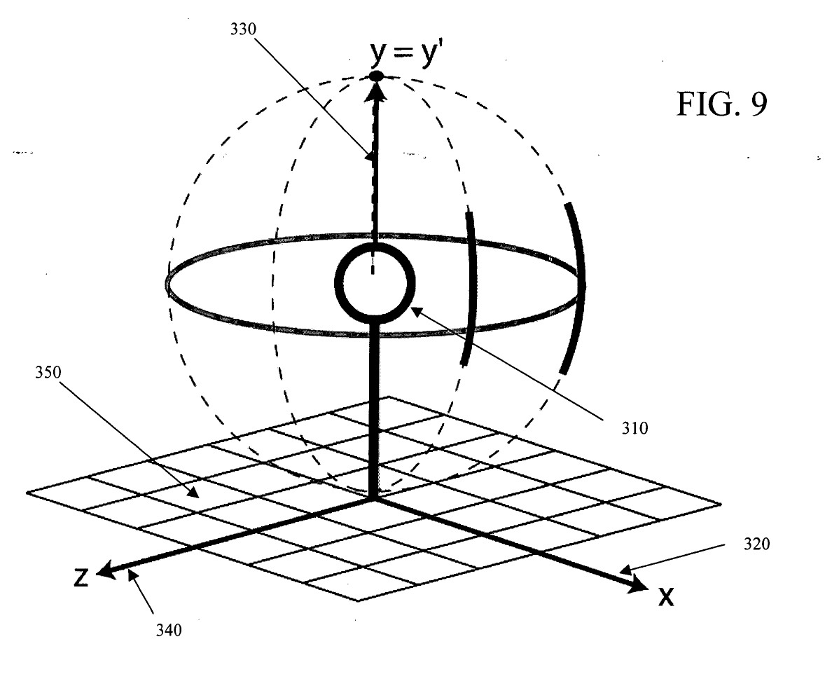

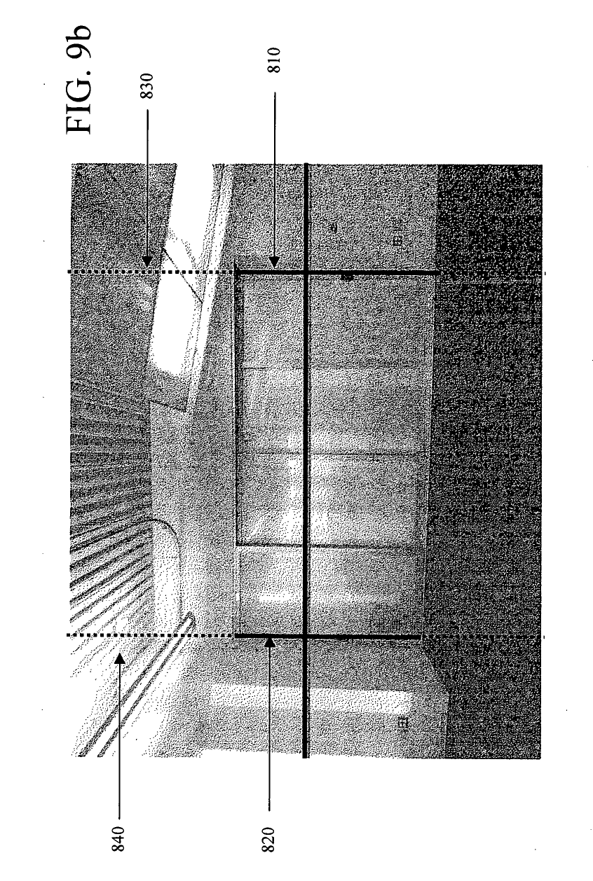

FIGS. 8a and 8b illustrate one embodiment of the local alignment step 105. The image panorama is presented to the user with the axes of global reference 300 imposed onto the image. However, at this point, the “up” vector of the image has not been identified, and therefore the features of the image are not aligned with the global reference 300. Using one or more interactive alignment tools, the user identifies two vertical features of the scene that the user believes to be substantially parallel, 810 and 820. Given that two parallel lines, when extended to infinity, meet at a point defined as their “vanishing point,” the system can extend the features 810 and 820 around the entire panorama, creating circles 830 and 840. The circles 830 and 840 intersect at point y′ 850—the vanishing point for the two lines 830 and 840 in three-dimensional coordinates. A reference line 860 is then created connecting the point y′ 850 with the point source 310 creating an “up” vector for the panorama. Rotating the image by an angle α 870 such that the reference line 860 is aligned with they axis 330 of the global reference 300, the features become locally aligned with they axis 330 of the global reference 300, as depicted in FIGS. 9a and 9b

In some embodiments, more than two features can be used to align the image panorama. For example, where three features are identified, three intersection points can be determined—one for each set of two lines. A true vanishing point can then be linearly interpolated from the three intersection points. This approach can be extended to include additional features as need or as identified by the user.

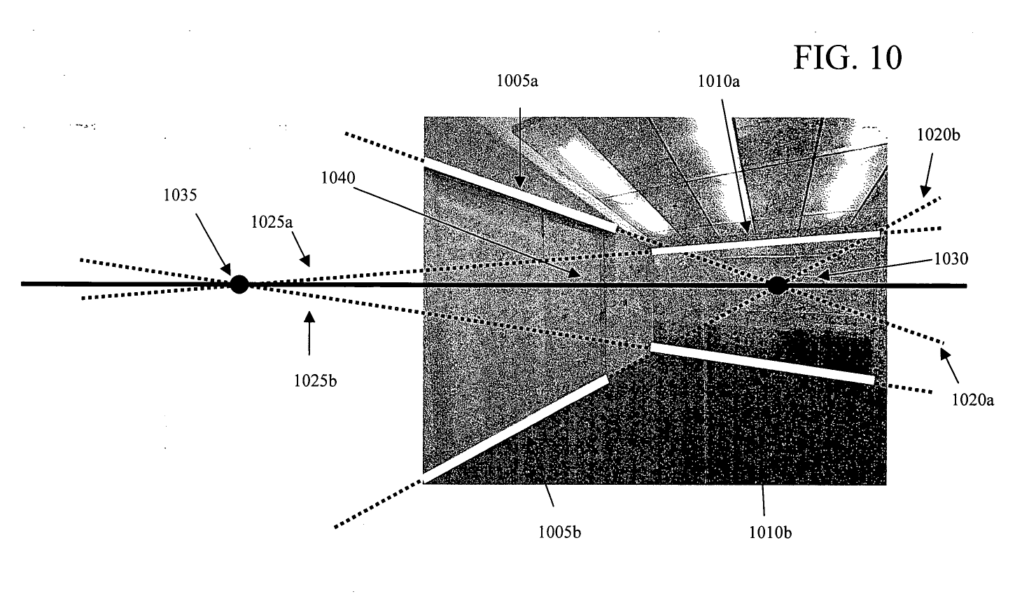

In another embodiment of the local alignment step 105, the system can determine the horizon line based on user's identification of horizontal features in the original panorama. Similar to the local alignment step described above, the user traces horizontal features that exist in the original panorama. Referring to FIG. 10, a user traces a first pair of lines 1005a and 1005b representing features of the image known to be substantially parallel to each other, and a second pair of lines 1010a and 1010b representing a second set of features in the image known to be substantially parallel to each other. Lines 1005a and 1005b are then extended to lines 1020a and 1020b respectively, and lines 1010a and 1010b are then extended to lines 1025a and 1025b respectively to the vanishing points of the two sets of parallel lines. The extensions intersect at points 1030 and 1035, and connecting the two intersection points with line 1140 provides a plane with which the image can be locally aligned.

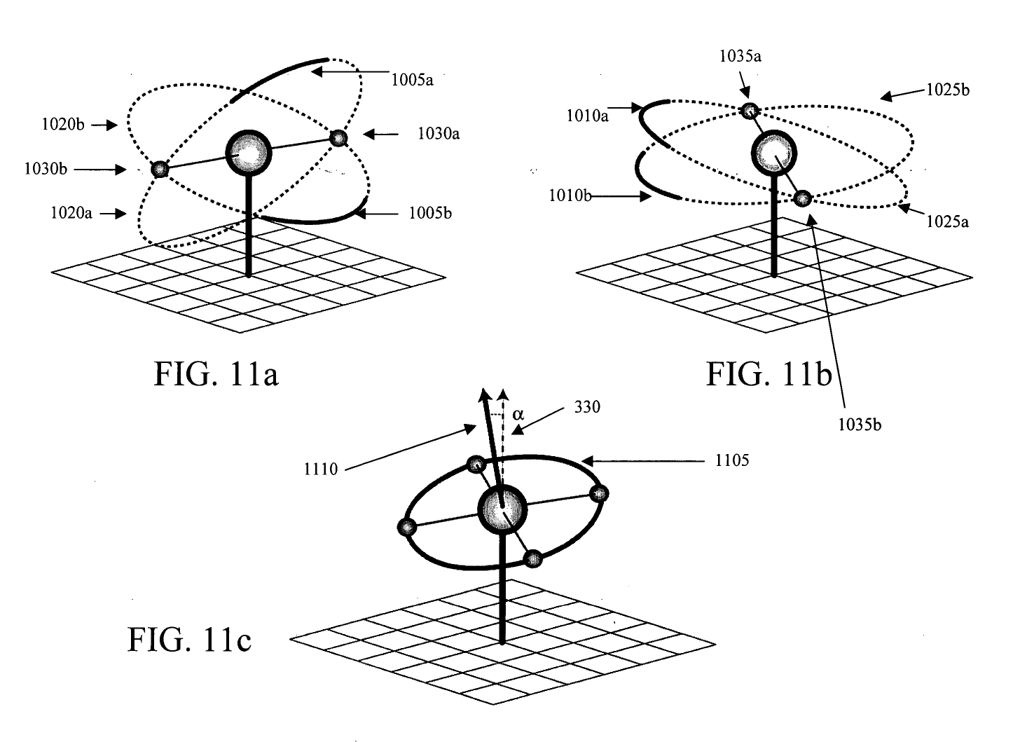

Referring to FIGS. 11a, 11b, and 11c, one set of extended lines 1020a and 1020b intersect at vanishing points 1030a and 1030b. A second set of extended lines 1025a and 1025b meet at vanishing points 1035a and 1035b. Using the four vanishing points, the plane 1105 can be defined, from which an “up” vector 1110 can be determined. This “up” vector can then be rotated such that it aligns with they axis 330 of the global reference 300, and therefore is locally aligned.

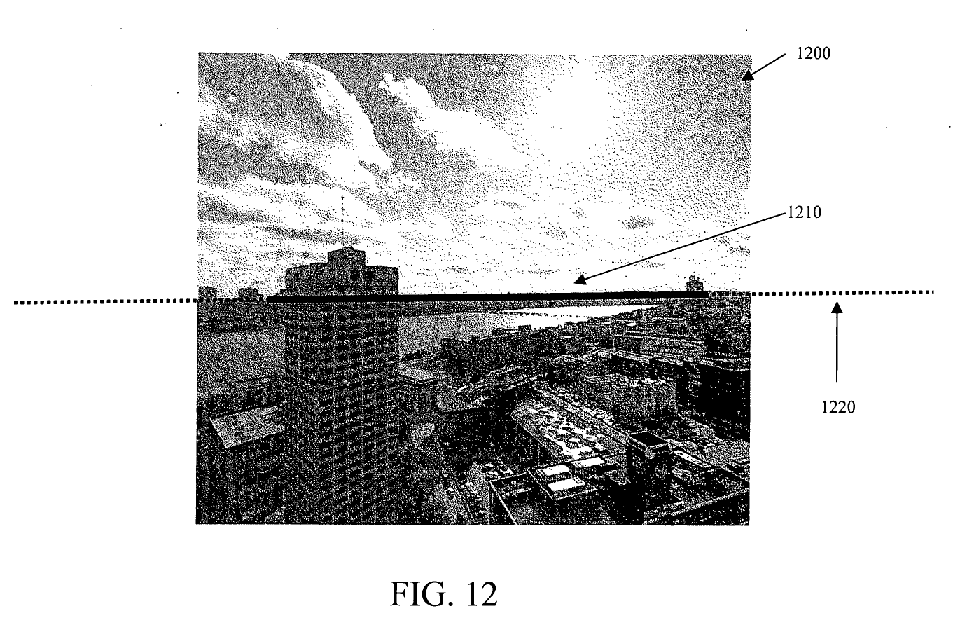

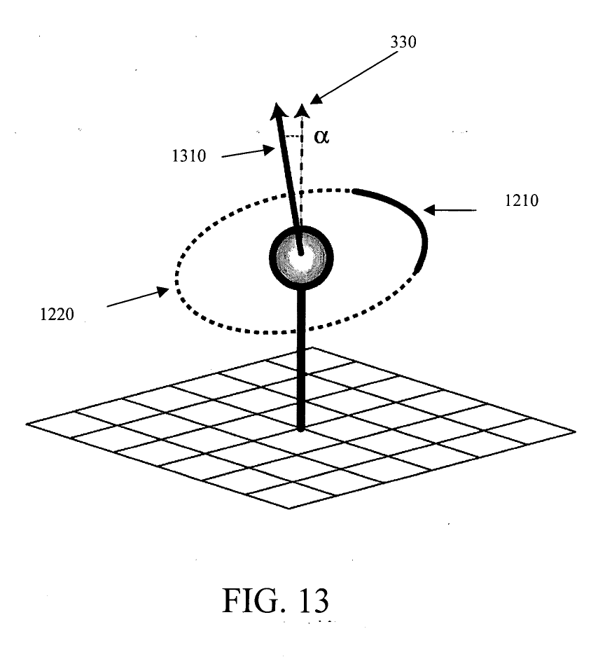

In another embodiment, a user indicates a horizon line by directly specifying the line segment that represents the horizon. This approach is useful when features of the image are not know to be parallel, or the image is of an outdoor scene such as FIG. 12. Referring to FIG. 12, the user traces a horizon line segment 1210 on the original panorama 1200. The identified horizon line 1210 can be extended out to infinity to create line 1220. Referring to FIG. 13, the extended horizon line 1220 creates a circle around the source position 310, thus creating a plane. The normal vector 1310 to the plane, where the circle lies, is then computed, thus determining the “up” vector for the image. The “up” vector 1310 is then rotated by an angle alpha to align to the “up” vector 1310 with the y axis 330 of the global reference 300.

In another embodiment of the local alignment step 105, a user employs a manual local alignment tool to rotate the original panorama to be aligned with the global reference coordinate system. The user uses a mouse or other pointing and dragging device such as a track ball to orient the panorama to the true horizon, i.e. a concentric circle around the panorama position that is parallel to the XZ plane.

Once a set of image panoramas are locally aligned to a global reference 300, the global alignment step 110 aligns multiple panoramas to each other by matching features in one panorama to a corresponding features in other panoramas. Generally, if a user can determine that a line representing the intersection of two planes in panorama 1 is substantially vertical, and can identify a similar feature in panorama 2, the correspondence of the two features allows the system to determine the proper rotation and translation necessary to align panorama 1 and panorama 2. Initially, the multiple image panoramas must be properly rotated such that the global reference 300 is consistent (i.e., the x, y and z axes are aligned) and once rotated, the image must be translated such that the relationship between the first camera position and the second camera position can be calculated.

FIG. 14a illustrates an image panorama 1400 of a building 1430 taken from a known first camera position. FIG. 14b illustrates a second image panorama 1410 of the same building 1430 taken from a second camera position. Although the two camera positions are known, the relationship between the two, i.e. how to translate features in the first panorama 1400 to the second panorama 1410 is not know. Note that facade 1440 is common to both images, but without a priori knowledge that the facades 1440 were in fact the same facade of the same building 1430, it would be difficult to align the two images such that they had a consistent geometry.

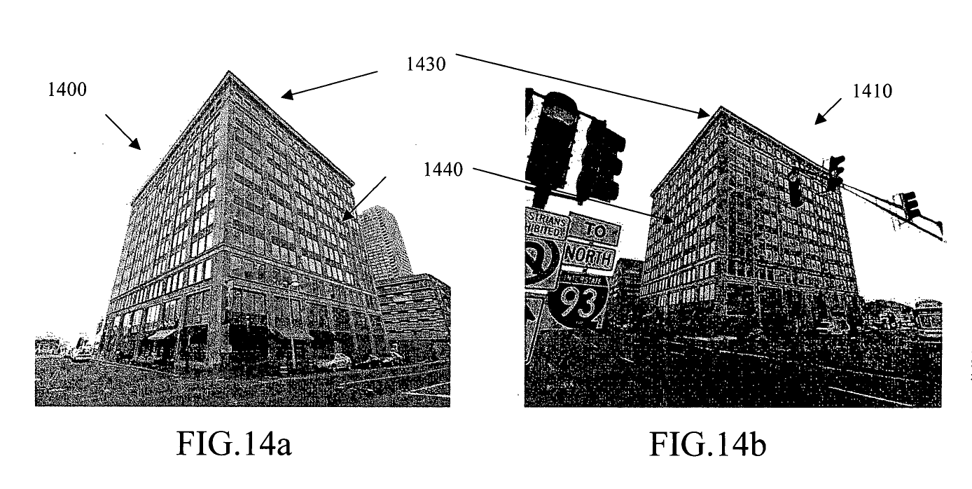

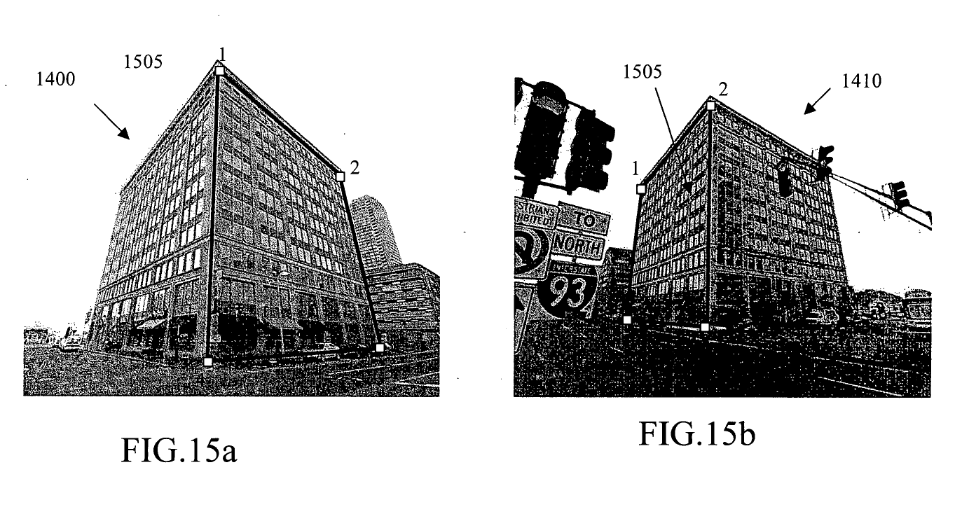

FIGS. 15a and 15b illustrate a step in the global alignment step 110. Using a drawing tool, tracing tool, pointing tool, or some other interactive device, a user identifies points 1, 2, 3, and 4 in the first panorama 1400, thus associating the facade 1440 with the plane 1505. Similarly, the user identifies the same four points in image 1410, creating the same plane 1505, although viewed from a different vantage point.

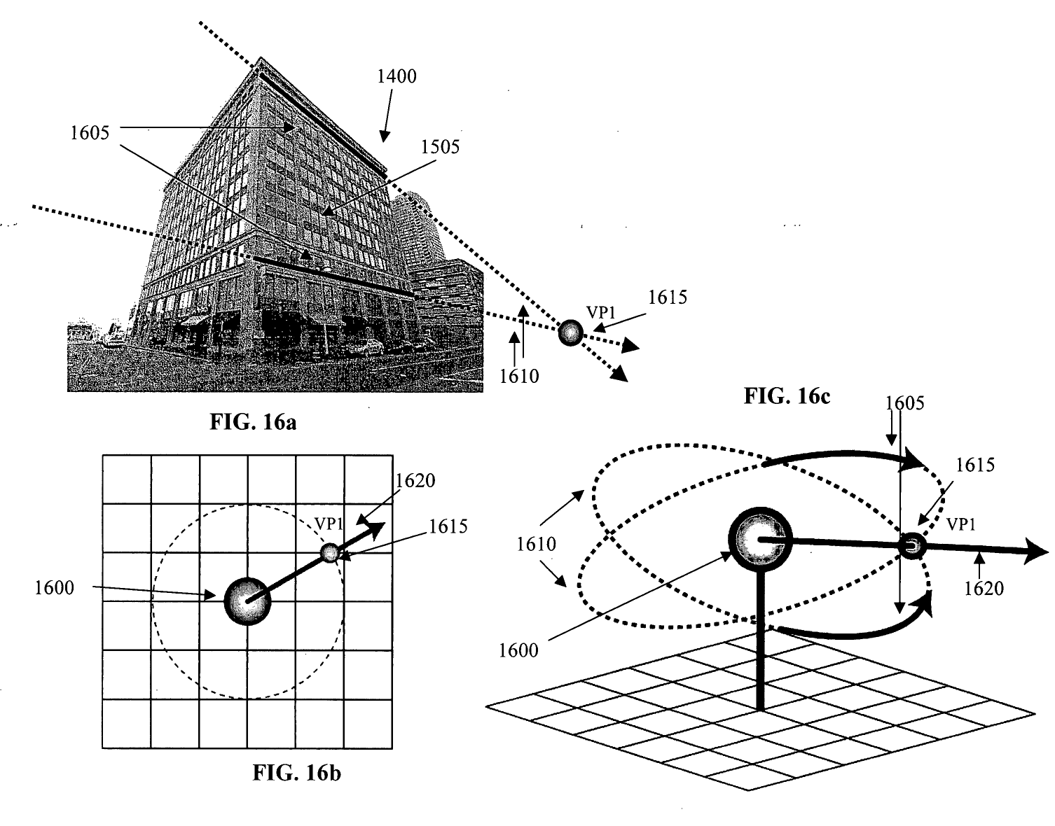

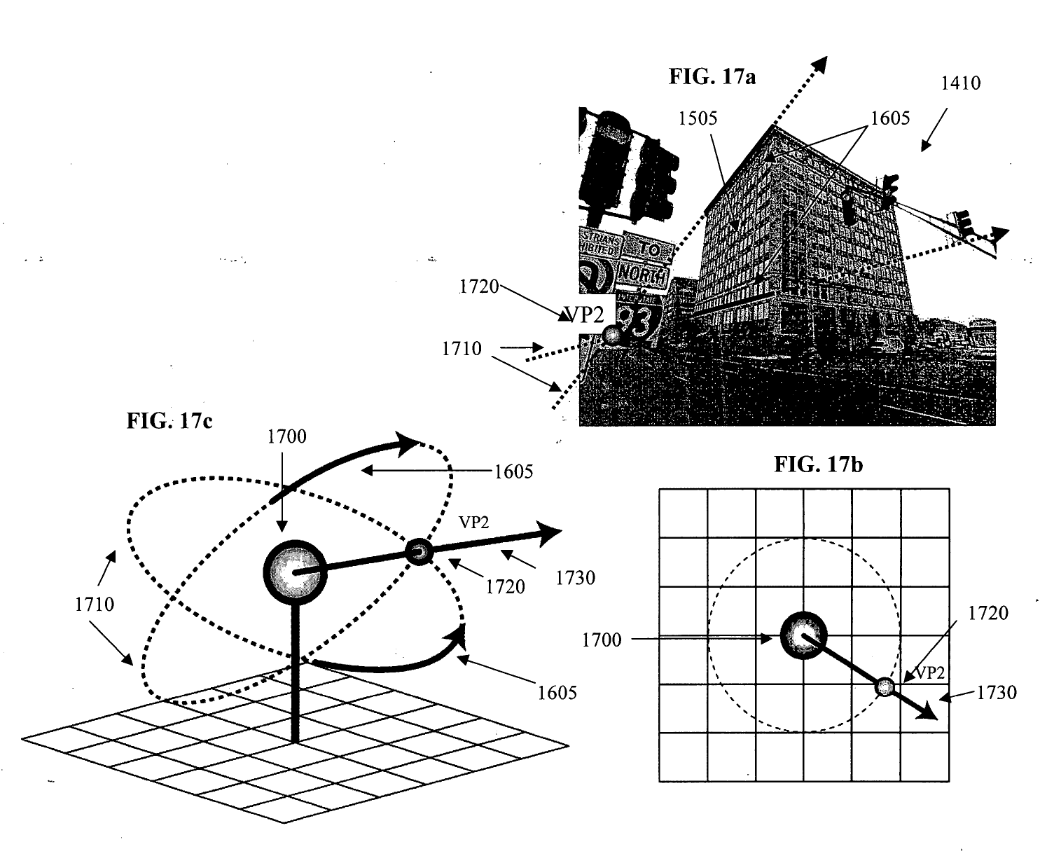

Continuing with the global alignment process and referring to FIGS. 16a, 16b, and 16c, the system can then extend the two elements 1605 of the plane 1505 as two lines 1610 out to infinity—thus identifying the vanishing point 1615 for the first image 1400. The line connecting the known camera position 1600 with the vanishing point 1615 represents a directional vector 1620 for the first image 1400 referring to FIGS. 17a, 17b, and 17c, the same elements 1605 are identified in the second image 1410 and used to create lines 1710. The lines 1710 are extended out to infinity, thus identifying the vanishing point 1720 for the second image 1410. Connecting the camera position 1700 to the vanishing point 1720 creates a directional vector 1730 for the second image, 1410.

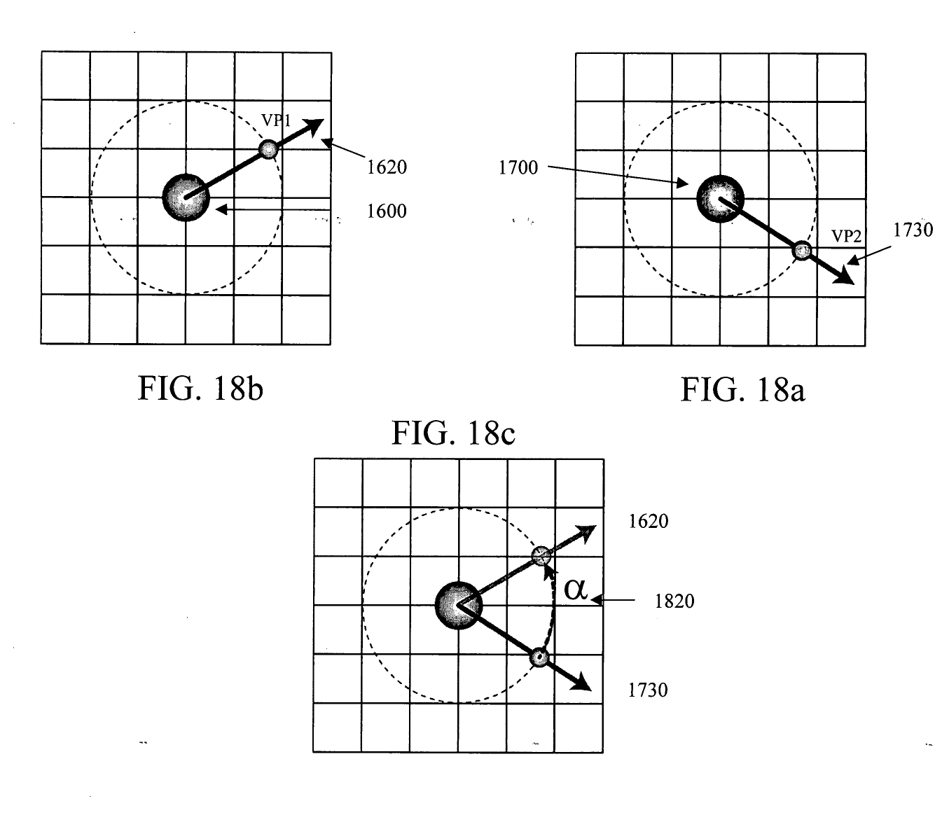

Referring to FIGS. 18a, 18b, and 18c, the rotation is completed by rotating the directional vector 1730 from the second image 1410 by an angle α such that it is aligned with the directional vector 1620 of the first image 1400. At this point, the images are correctly rotated relative to each other in the global reference 300, however their position in the global reference 300 relative to each other is still unknown.

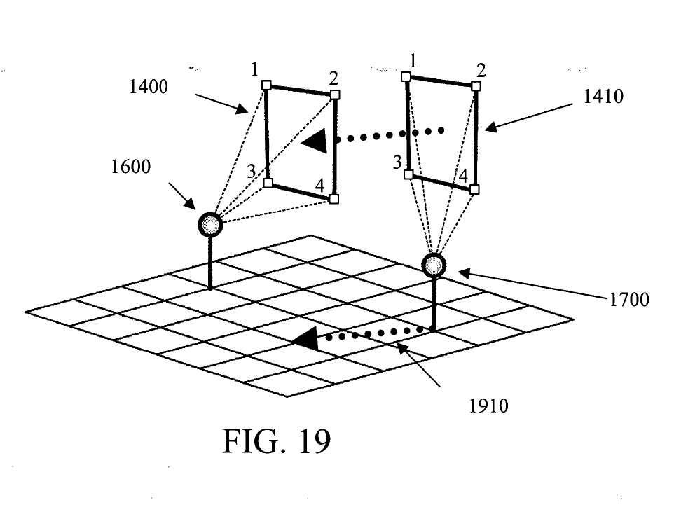

Once the panoramas are properly rotated, the second panorama can be translated to the correct position in world coordinates to match its relative position to the first panorama. As shown in FIG. 19, a simple optimization is technique is used to match the four lines from panorama 1410 to the respective four lines from panorama 1400. (As described before, the objective is to provide the simplest user interface to determine the panorama position.)

The optimization is formulated such that the closest distances between the corresponding lines from one panorama to the other are minimized, with a constraint that the panorama positions 1600 and 1700 are not equal. The unknown parameters are the X, Y, and Z position of panorama position 1700. The weights on the optimization parameters may also be adjusted accordingly. In some embodiments, the X and Z (i.e. the ground plane) parameters are given greater weight than Y, since real-world panorama acquisition often takes place at an equivalent distance from the ground.

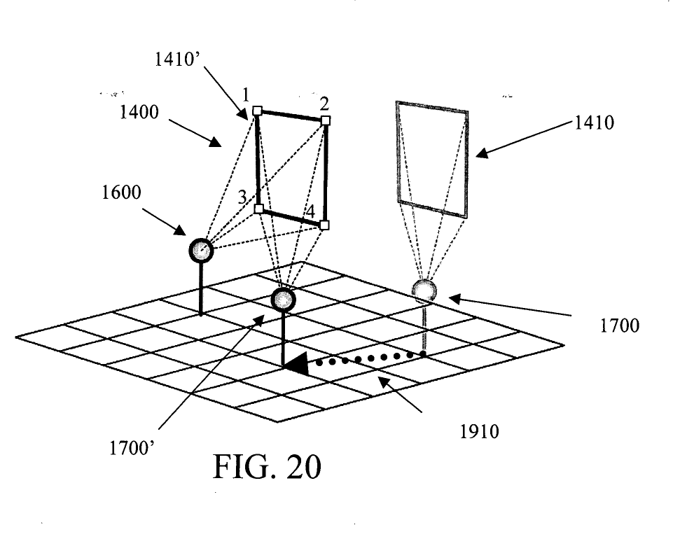

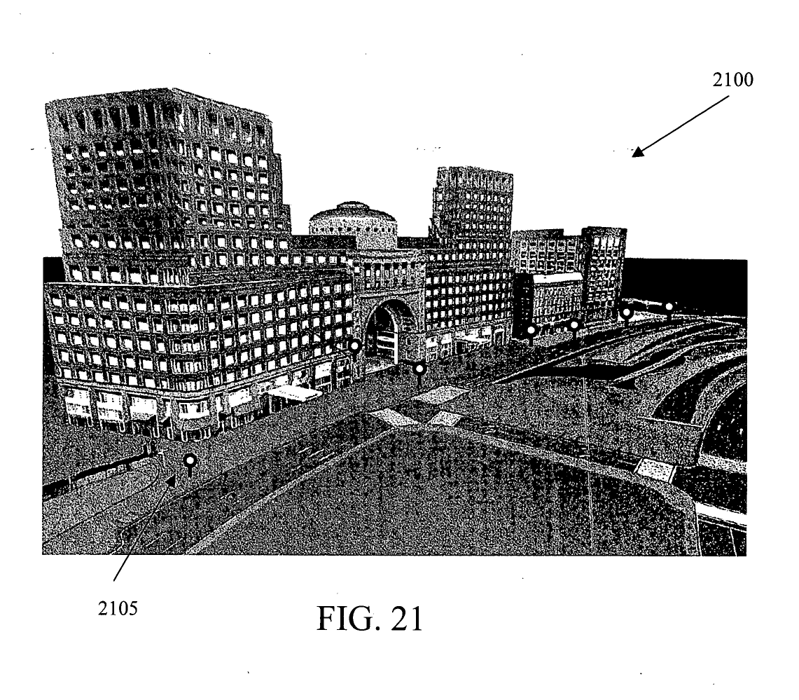

Similarly, another technique is to use an extrusion tool, as is described in detail herein, to create two separate matching facade geometries from each panorama. The system then optimizes the distance between four corresponding points to determine the X, Y, Z position of panorama 1410, as shown in FIG. 20. FIG. 21 illustrates one possible result of the process. The model 2100 consists of multiple image panoramas taken from various acquisition points (e.g. 2105) throughout the scene.

By aligning multiple panoramas in serial fashion, this allows multiple users to access and align multiple panoramas simultaneously, and avoids the need for global optimization routines that attempt to align every panorama to each other in parallel. For example, if a scene was created using 100 image panoramas, a global optimization routine would have to resolve 100¹⁰⁰ possible alignments. Taking advantage of the user's knowledge of the scene and providing the user with interactive tools to supply some or all of the alignment information significantly reduces the time and computational resources needed to perform such a task.

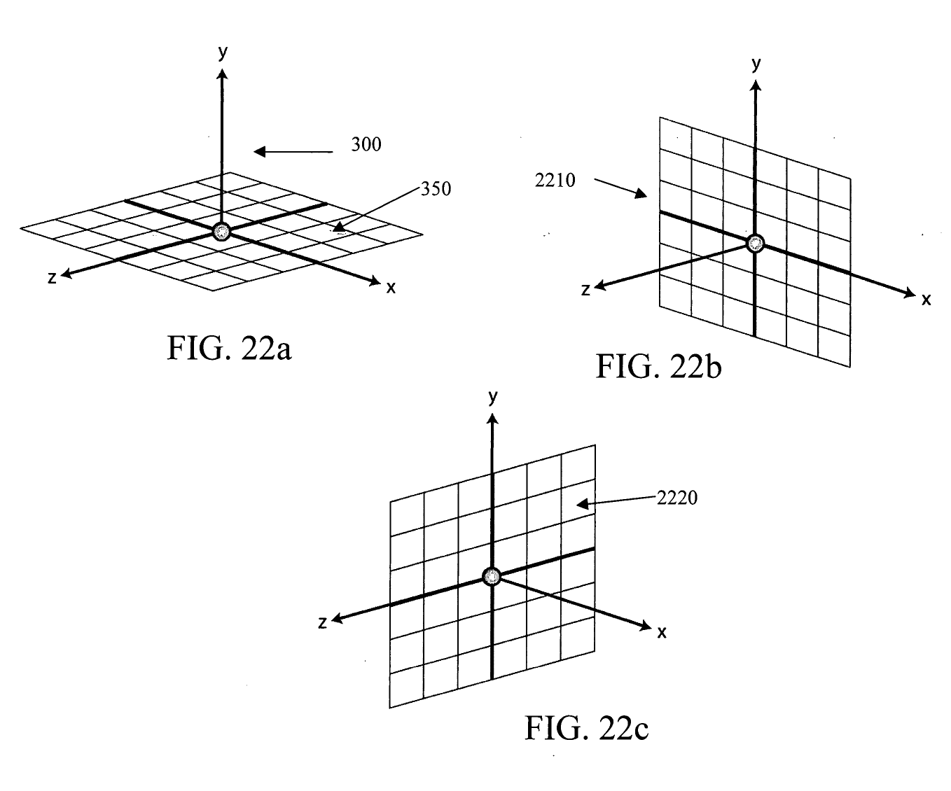

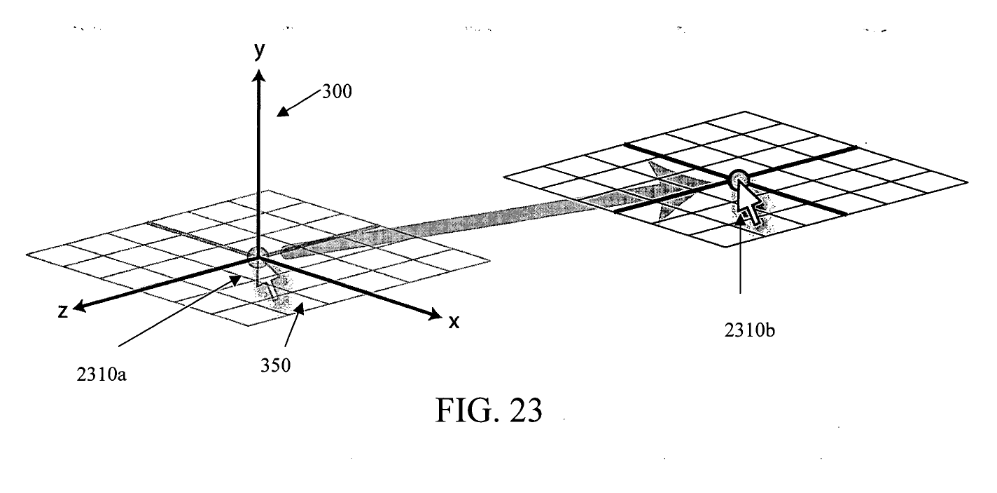

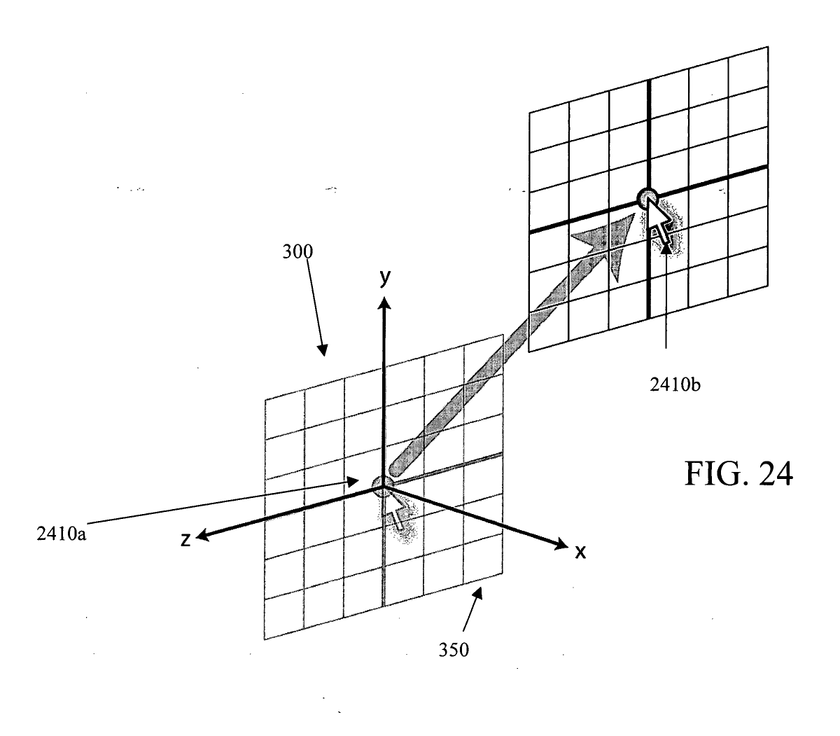

FIGS. 22-27 illustrate the process of identifying and manipulating the reference plane 350 to allow the user to create and edit a geometric model using the global reference 300. FIGS. 22a, 22b, and 22c illustrate three possible alternatives for placement of the reference plane 350. By default, the reference plane 350 is placed on the x-z plane. However, the user may, using interactive tools or by specifying at a global level within the system, that the reference plane 2210 be the x-y plane as shown in FIG. 22b, or the reference plane 2220 could also be on the y-z plane, as shown in FIG. 22c. Furthermore, the reference plane 350 can be moved such that the origin of the global reference 300 lies at a different location in the image. For example, and as illustrated in FIG. 23, the reference plane 350 has an origin at point 2310a of the global reference 300. Using an interactive tool such as a drag and drop tool or other similar device, the user can translate the origin to another point 2310b in the image, while keeping the reference plane on the x-z plane. Similarly, as illustrated in FIG. 24, if the reference plane 350 is on the y-z plane with an origin at point 2410a, the user can translate the origin to another point 2410b in the y-z plane.

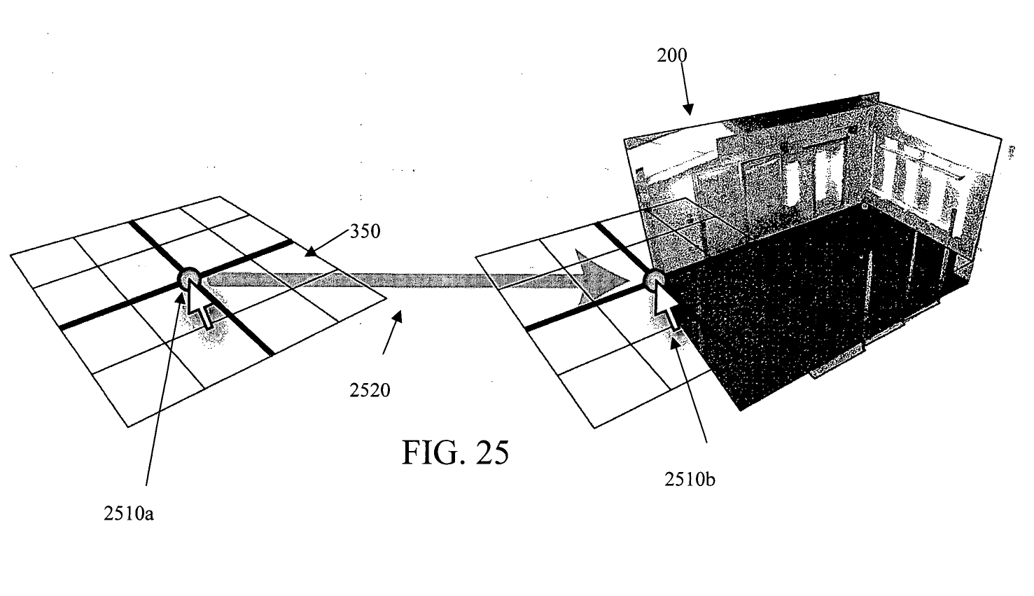

In some instances, it may be beneficial for the origin of the global reference 300 to be co-located with a particular feature in the image. For example, and referring to FIG. 25, the origin 2510a of the reference plane 350 is translated to the vicinity of a feature of the existing geometry such a the corner of the room 200, and the reference plane 350 “snaps” into place with the origin at the point 2510b.

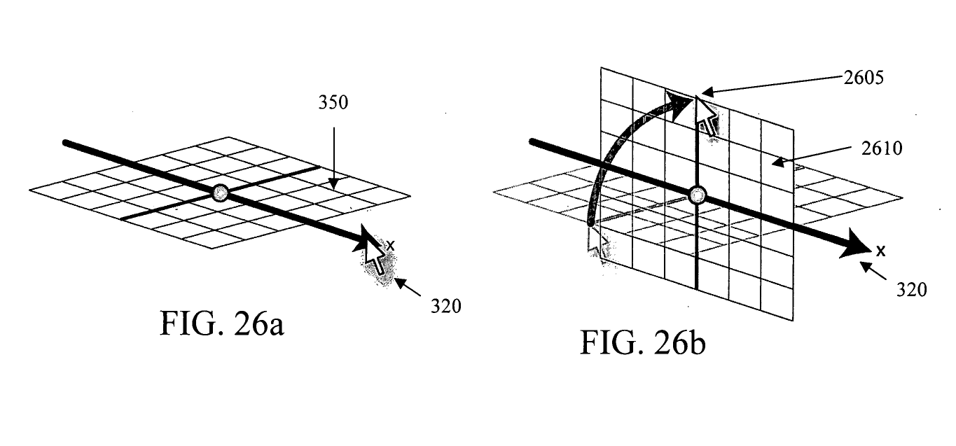

In other embodiment, the user can rotate the reference plane about any axis of the global reference 300 if required by the geometry being modeled. Referring to FIG. 26a, the user specifies an axis such as the x axis 320 on which the reference plane 350 currently sits. Referring to FIG. 26b, the user then selects the reference plane using a pointer 2605 and rotates the reference plane into its new orientation 2610. Geometries may then be defined using the rotated reference plane 2610. For example, if the default reference plane 350 was along the x-z plane, but the feature to be modeled or edited was a window or billboard, the reference plane can be rotated such that it is aligned with the wall on which the window or billboard exist.

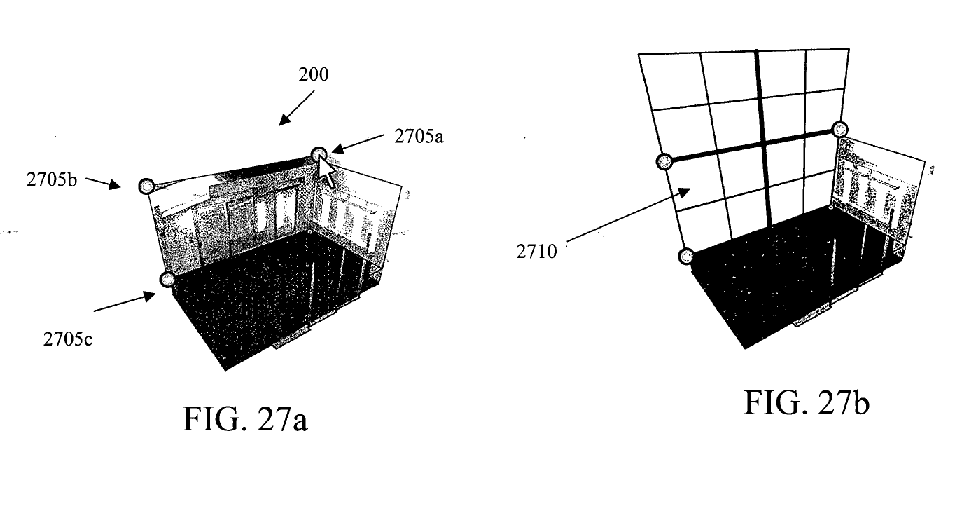

It another embodiment, the user can locate a reference plane by identifying three or more features on an existing geometry within the image. For example and referring to FIGS. 27a and 27b, a user may wish to edit a feature on a wall of a room 200. The user can identify three points 2705a, 2705b, and 2705c of the wall to the system, which can then determine the reference plane 2710 for the feature that contains the three points.

Once the image panoramas are aligned with each other and a reference plane has been defined, the user creates a geometric model of the scene. The geometric modeling step 115 includes using one or more interactive tools to define the geometries and textures of elements within the image. Unlike traditional geometric modeling techniques where pre-defined geometric structures are associated with elements in the image in a retrofit manner, the image-based modeling methods described herein utilize visible features within the image to define the geometry of the element. By identifying the geometries that are intrinsic to elements of the image, the textures and lighting associated with the elements can be then modeled simultaneously.

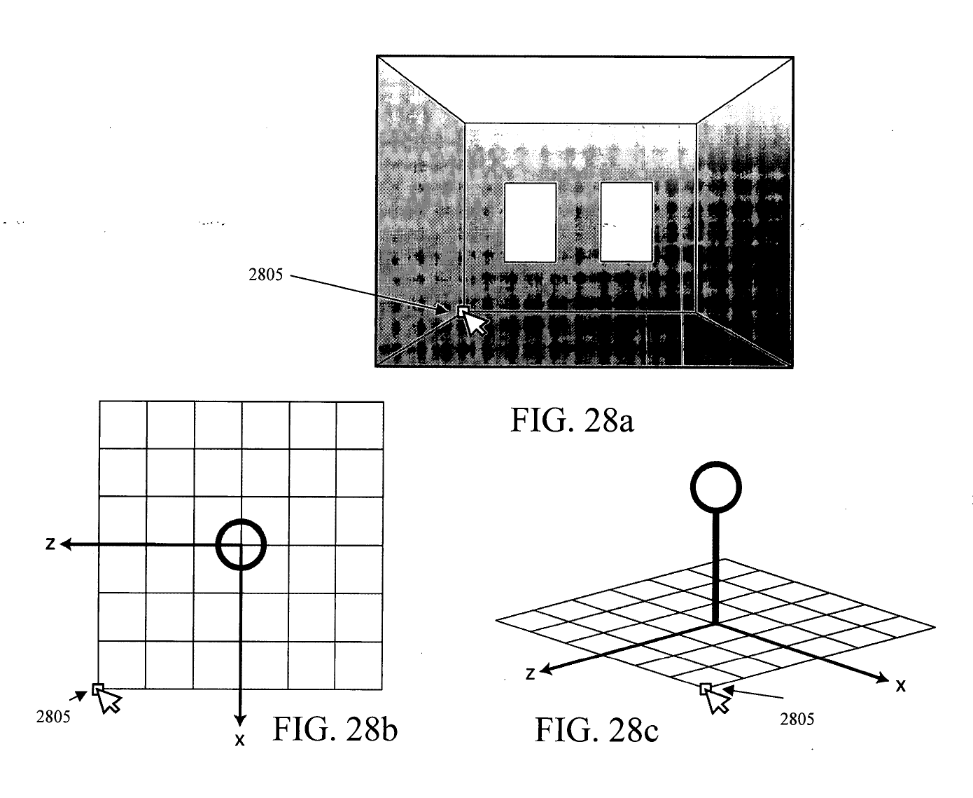

After the input panoramas have been aligned, the system can start the image-based modeling process. FIGS. 28-34 describe the extrusion tool which is used to interactively model the geometry with the aid of the reference plane 350. As an example, FIGS. 28a, 28b, and 20c illustrate three different views of a room. FIG. 28a illustrates the viewpoint as seen from the center of the panorama, and displays what the room might look like to the user of a computerized software application that interactively displays the panorama of a room in two dimensions on a display screen. FIG. 28b illustrates the same room from a top-down perspective, while FIG. 28c represents the room modeled in three-dimensions using the global reference 300. To initiate the modeling step 115, a user identifies a starting point 2805 on the screen image of FIG. 28a. That point 2805 can be then mapped to a corresponding location in the global reference 300 as shown in FIG. 28c by utilizing the reference plane.

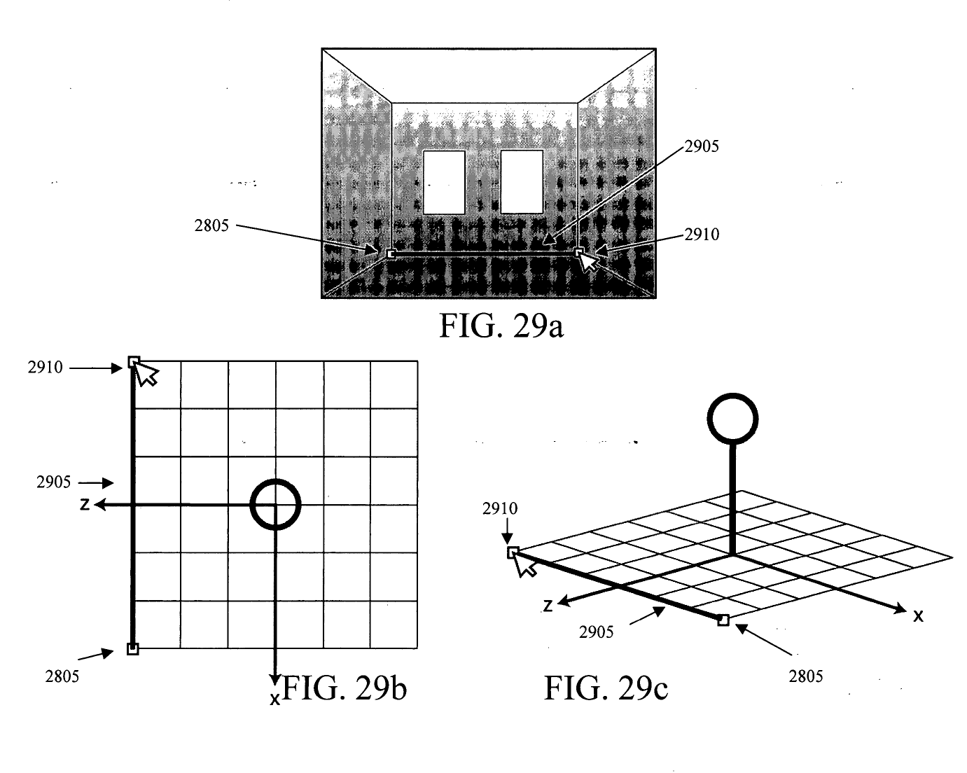

FIGS. 29a, 29b, and 29c illustrate the use of the reference plane tool with which the user identifies the ground plane 350. Starting at the previously identified point 2805, the user draws a line 2905 following the intersection of one wall with the floor to a point 2920 in the image representing the intersection of the floor with another wall.

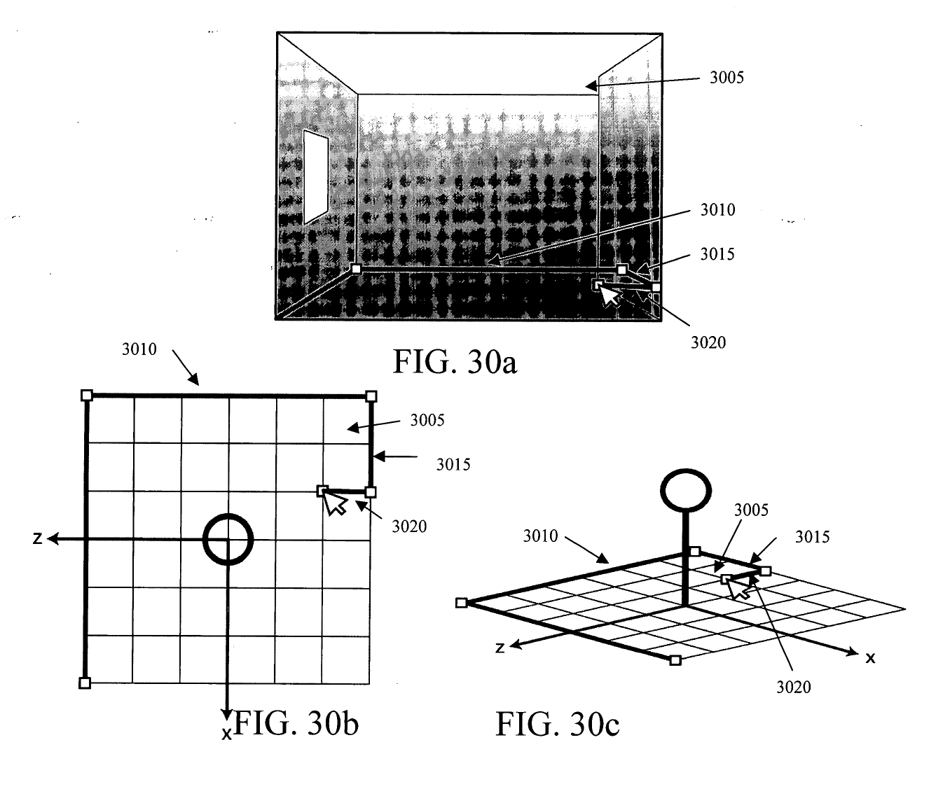

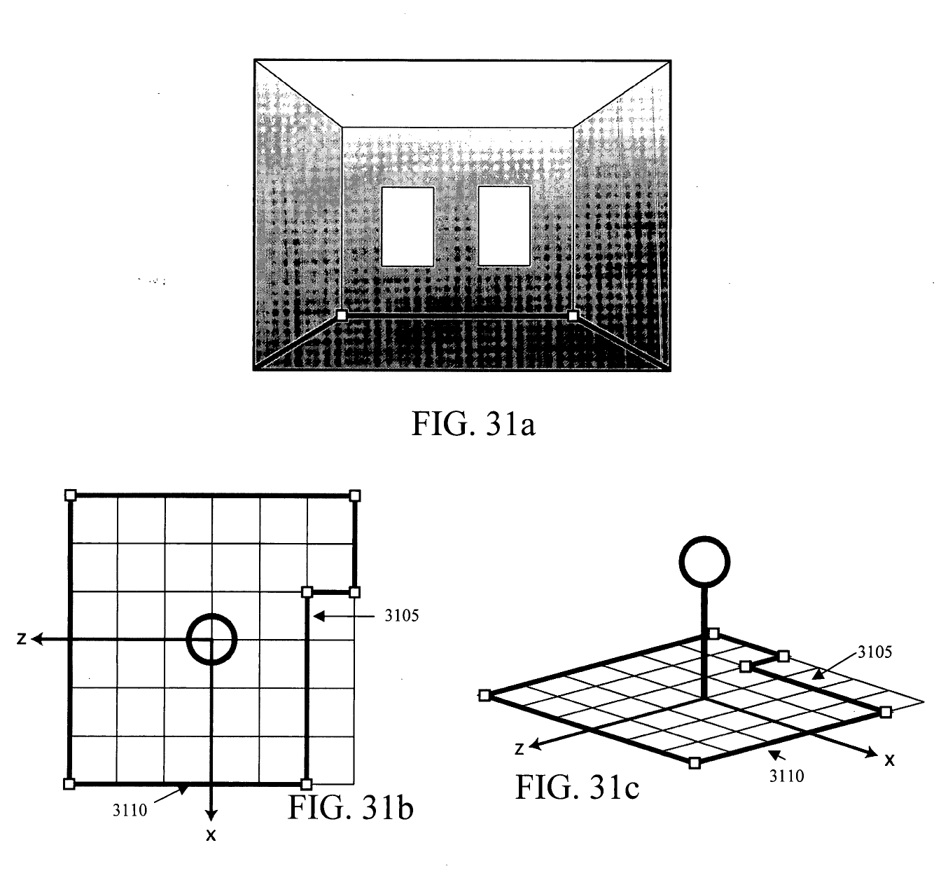

FIGS. 30a, 30b, and 30c further illustrate the use of the reference plane tool with which the user identifies the ground plane 350. Continuing around the room, the user traces lines representing the intersections of the floors with the walls. In some embodiments where the room being modeled is not a quadrilateral, the user traces around the features that define the peculiarities of the room. For example, area 3005 represents a small alcove within the room which cannot be seen from some perspectives. However lines 3010, 3015, and 3020 can be drawn to define the alcove 3005 such that the model is consistent with the actual room shape by constraining the floor-wall edge drawing to match the existing shape and feature of the room. Multiple panorama acquisition can be used to fill in the occluded information not visible from the current panoramic view. The process continues until the entire ground plane has been traced, as illustrated in FIGS. 31a, 31b, and 31c with lines 3105 and 3110.

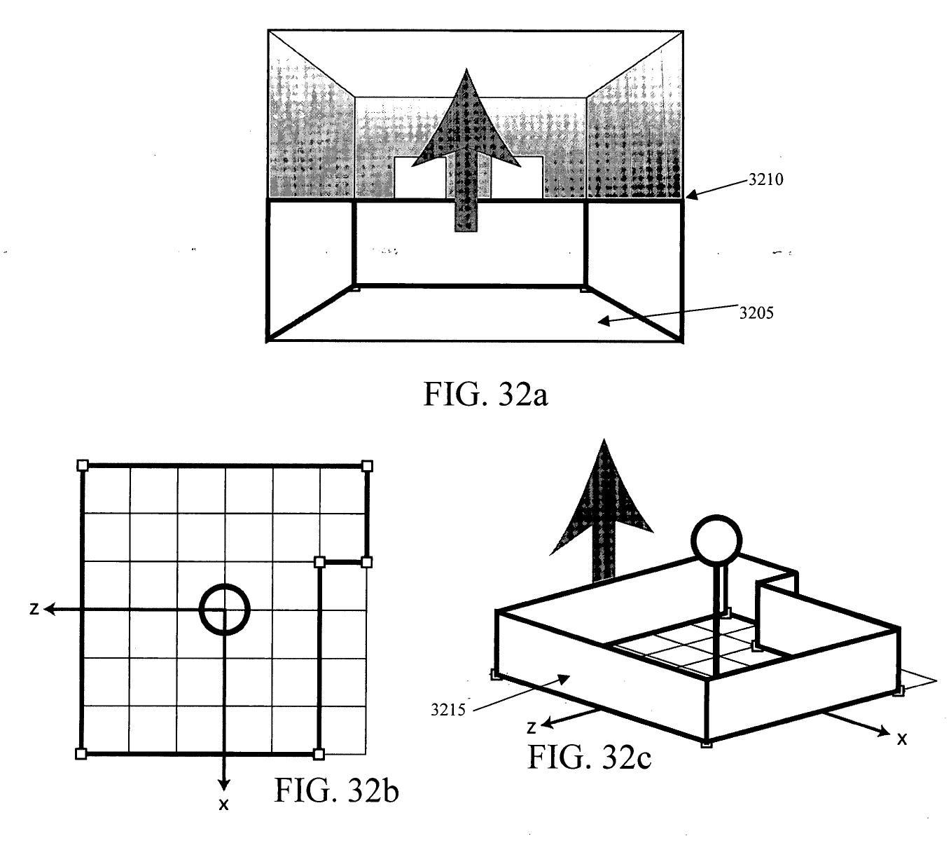

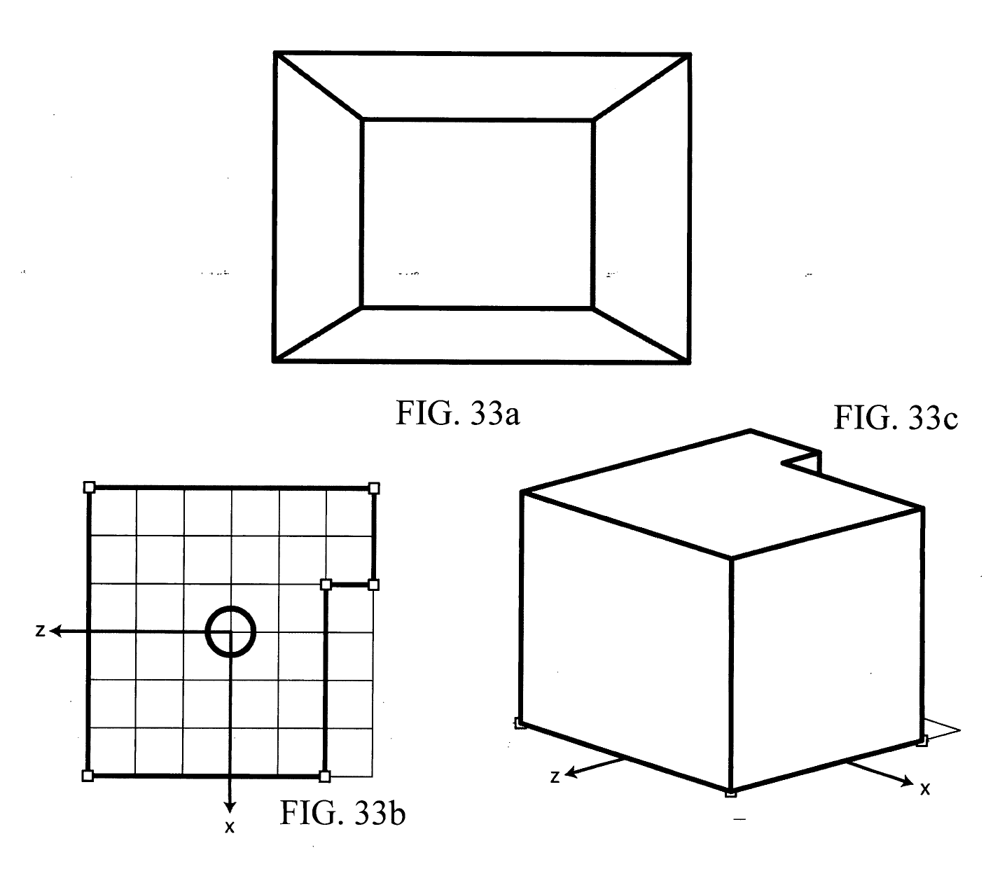

With the reference plane defined, the user can “extrude” the walls based on the known shape and alignment of the room. FIGS. 32a, 32b, and 32c illustrate the use of an extrusion tool whereby the user can pull the walls up from the floor 3205, along the walls to create a complete three-dimensional model of the room. The height of the walls can be supplied by the user—i.e. input directly, or by using a mouse to trace the height of the walls, or in some embodiments the wall height may be predetermined. The result of which is illustrated by FIGS. 33a, 33b and 33c.

In some embodiments, the reference plane extrusion tool can be used without an image panorama as an input. For example, where scene is built using geometric modeling methods not including photos, the extrusion tool can extend features of the model, and create additional geometries within the model based on user input.

In some embodiments, the reference plane tool and the extrusion tool can be used to model curved geometric elements. For example, the user can trace on the reference plane the bottom of a curved wall and use the extrusion tool to create and texture map the curved wall.

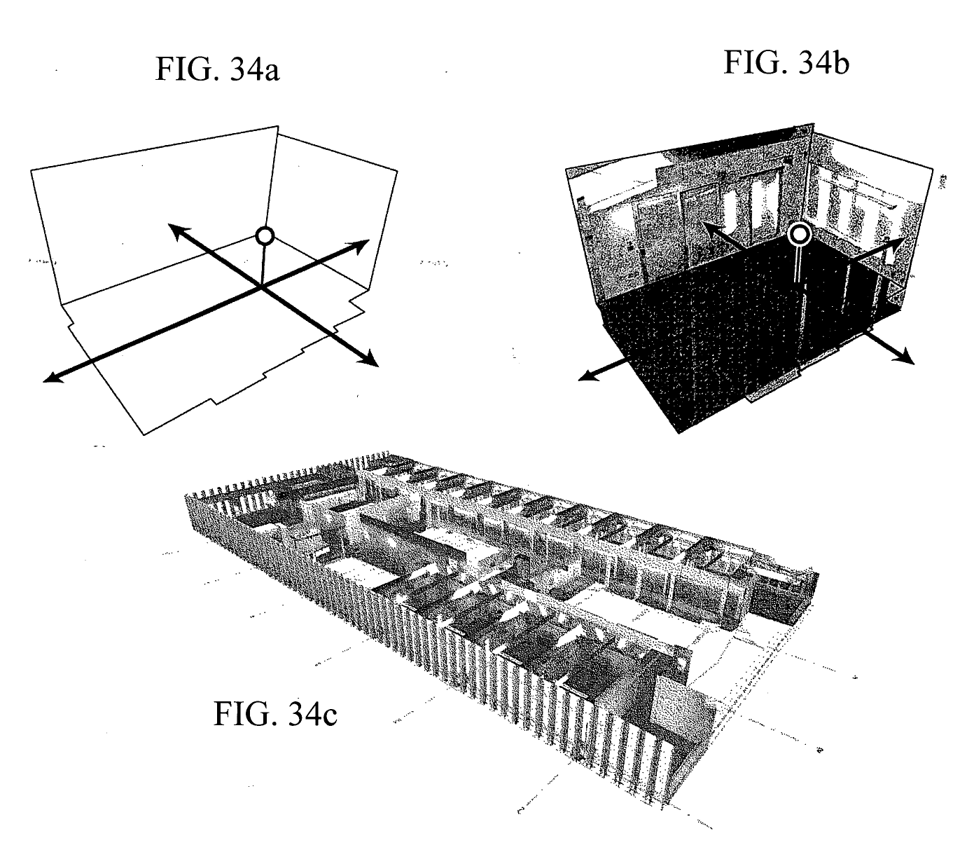

FIGS. 34a, 34b, and 34c illustrate one example of an interior scene modeled using a single panoramic input image, the reference plane tool coupled with the extrusion tool. FIG. 34a illustrates the wire-framed geometry and FIG. 34b shows the full texture mapped model. FIG. 34c shows a more complex scene of an office space interior that was modeled using the aforementioned interactive tools. In some embodiments, the number of panoramas used to create the model can be large, for example the image of FIG. 26c was modeled using more than 30 image panoramas as input images.

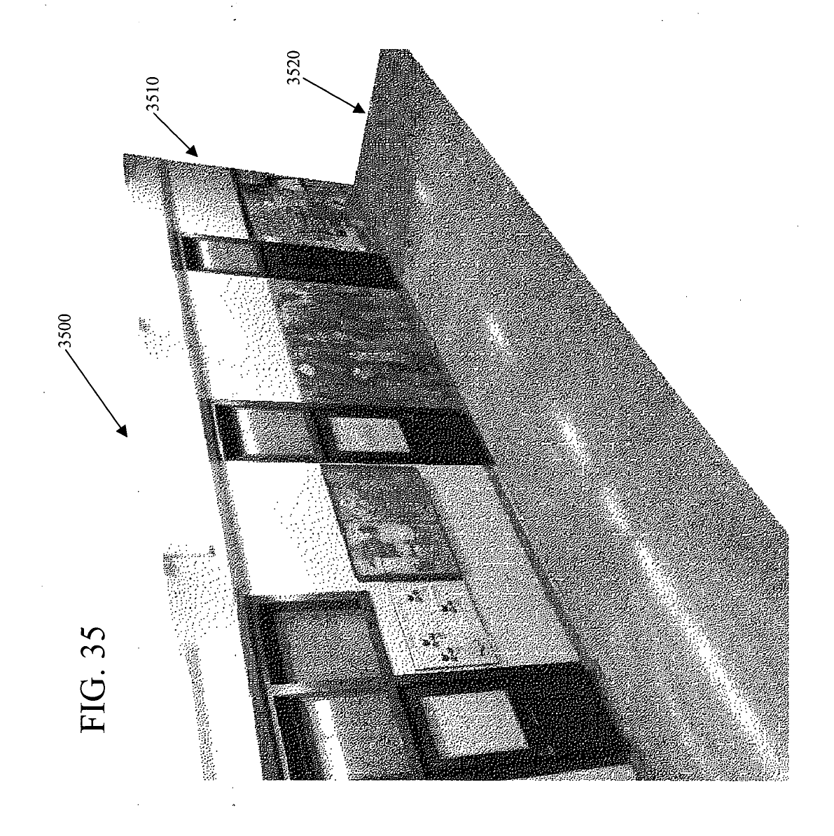

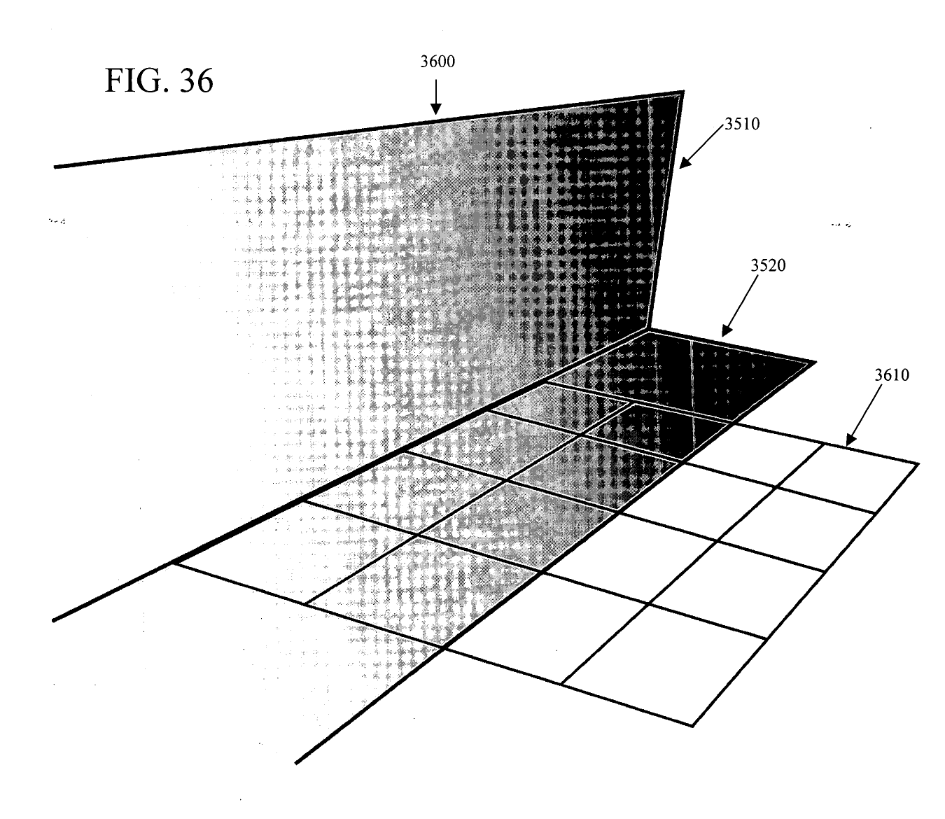

FIGS. 35 through 40 illustrate the use of a reference plane tool and a copy/paste tool for defining geometries within an image and applying edits to the defined geometries according to one embodiment of the invention. FIG. 35 illustrates a three-dimensional image of a hallway 3500. In this image, the floor 3520 and the wall 3510 are the only two geometric features defined. Thus, there is no information allowing the system to distinguish features on the wall or floor as separate geometries, such as a door, a window, a carpet, a tile, or a billboard. FIG. 36 illustrates a three-dimensional model 3600 of the image 3500, including a default reference plane 3610. As discussed, the reference plane may be user identified.

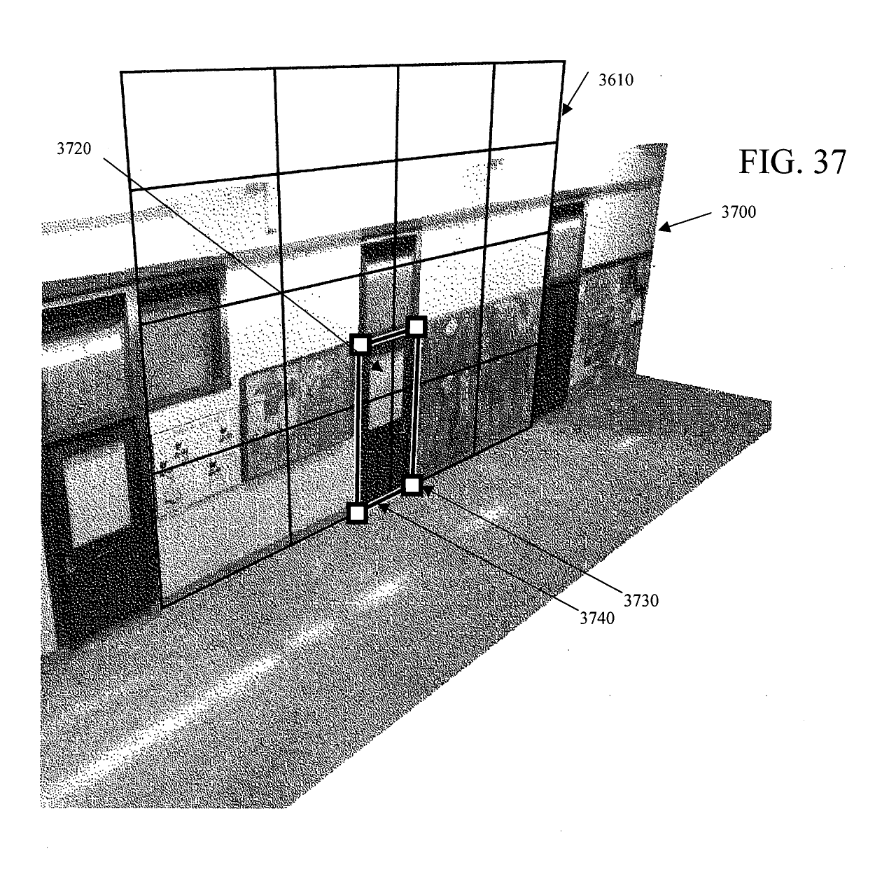

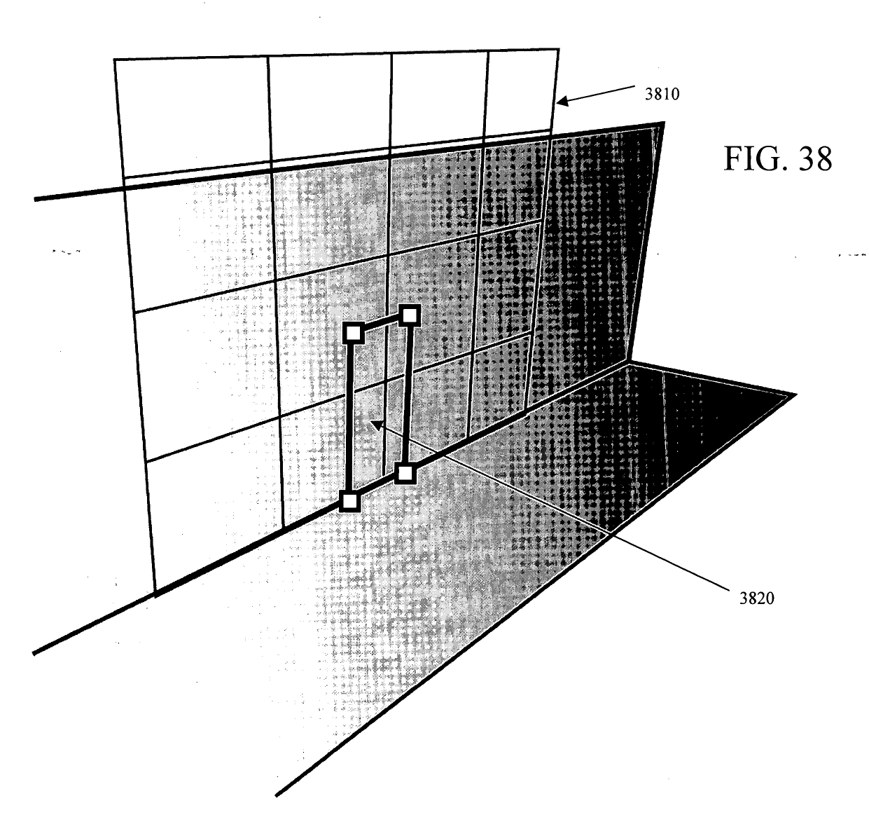

To define additional geometric features, the default reference plane 3610 is rotated onto the defined geometry containing the feature to be modeled such that the user can trace the feature with respect to the reference plane 3610. For example, as illustrated in FIG. 37, the default reference plane 3610 is rotated and translated onto the wall 3700 of the image allowing the user to identify a door 3720 as a defined feature with an associated geometry. The user may use one or more drawing or edge detection tools to identify corners 3730 and edges 3740 of the feature, until the feature has been identified such that it can be modeled. In some embodiments, the feature must be completely identified, whereas in other embodiments the system can identify the feature using only a fraction of the set of elements that define the feature. FIG. 38 illustrates the identified feature 3820 relative to the rotated and translated reference plane 3810 within the three-dimensional model.

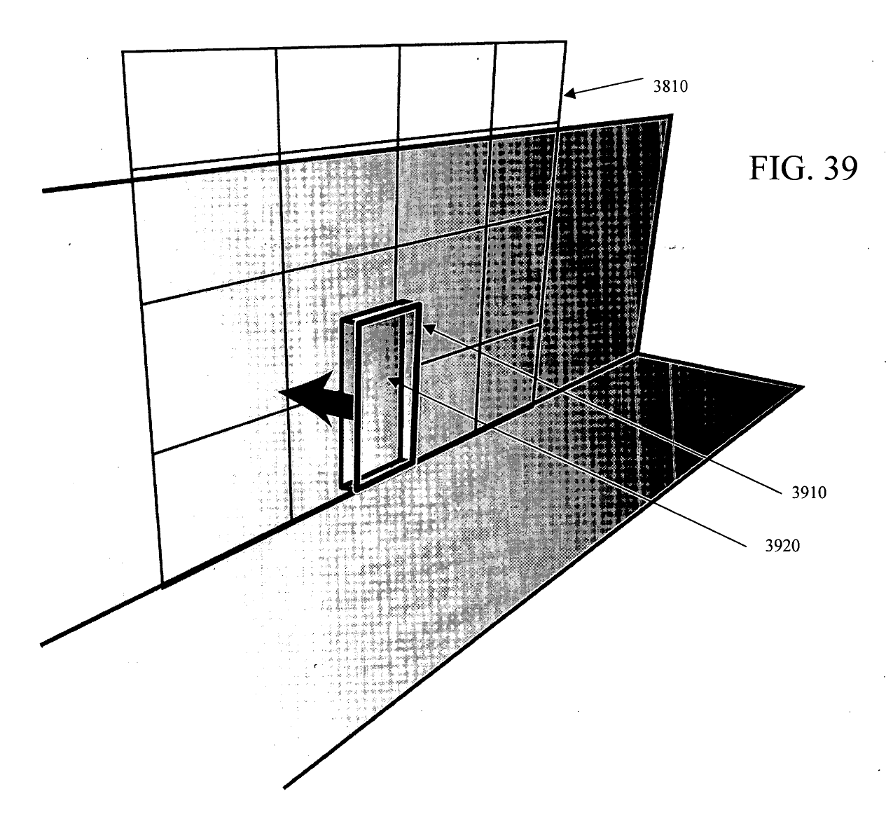

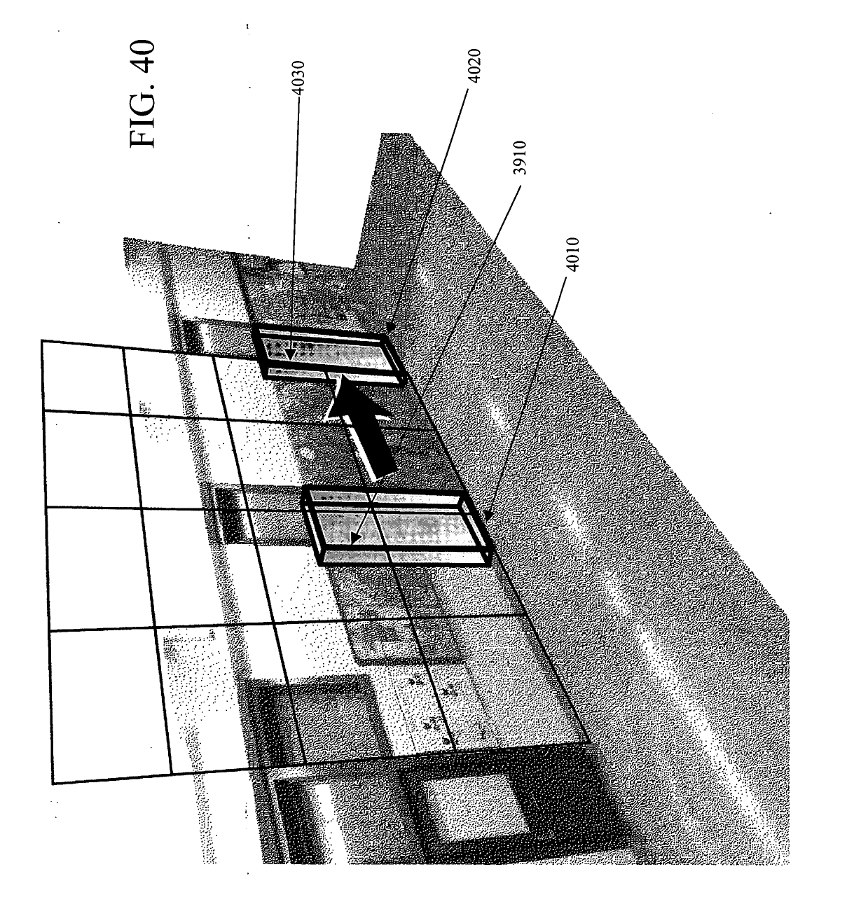

FIG. 39 illustrates the process by which a user can extrude the feature 3910 from the reference plane 3810, thus creating a separate geometric feature 3920, which in turn can be edited, copied, pasted, or manipulated in a manner consistent with the model. For example, as illustrated in FIG. 40, the door 3910 is copied from location 4010 to location 4020. The coped image retains the texture information from its original location 4210, but it is transformed to the correct geometry and luminance for the target location 4020.

The texture projection step 120 includes using one or more interactive tools to project the appropriate textures from the original panorama onto the objects in the model. The geometric modeling step 115 and texture mapping step 120 can be done simultaneously as a single step from the user's perspective. The texture map for the modeled geometry is copied from the original panorama, but as a rectified image.

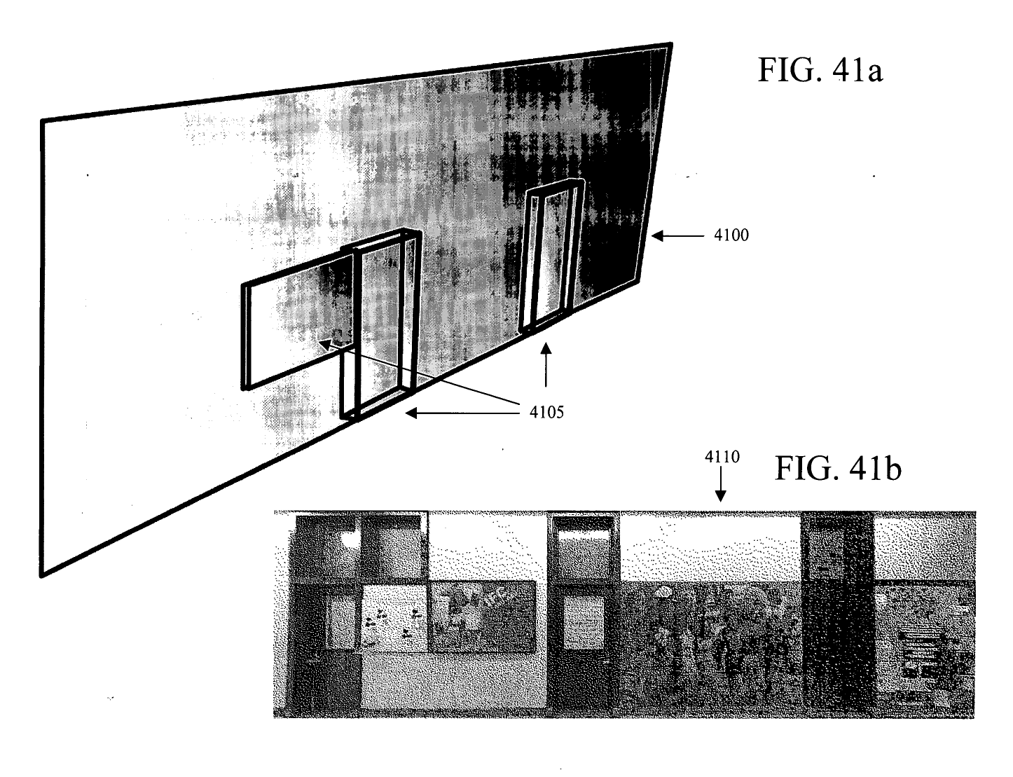

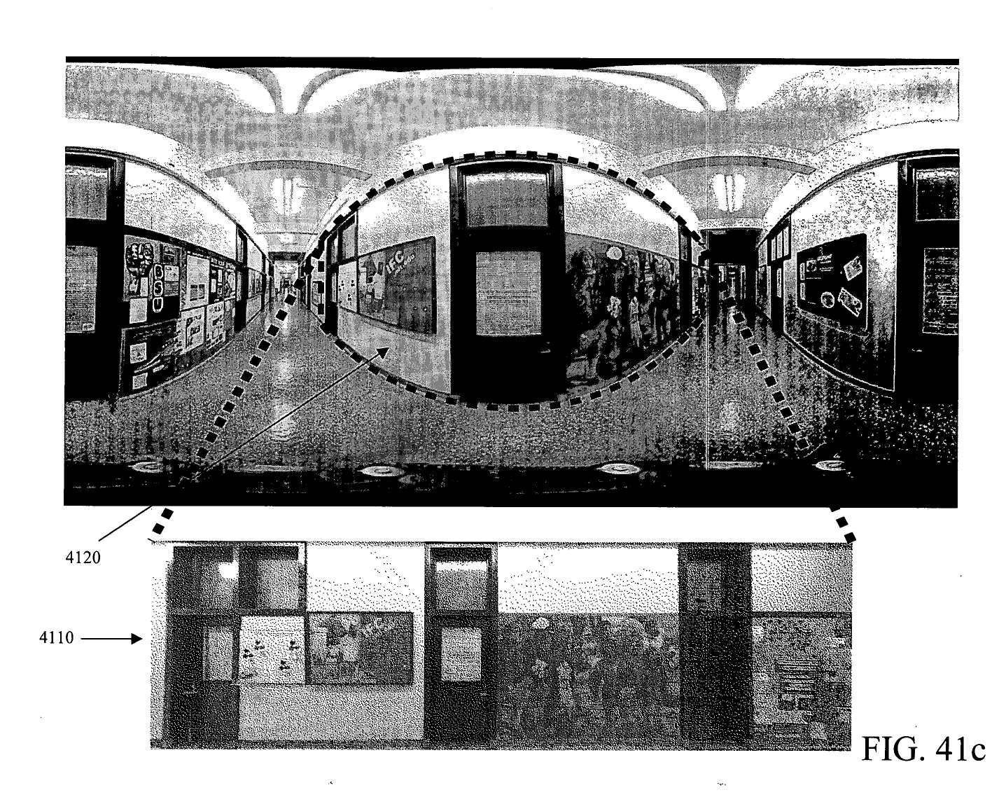

As shown in FIGS. 41a, 41b, and 41c, the appropriate texture map, a sub-part of the original panorama, has been rectified and scaled to fit the modeled geometry. FIG. 41a illustrates the geometric representation 4105 of the scene, with individual features of the scene 4105 also defined. FIG. 41b illustrates the texture map 4110 taken from the image panorama as applied to the geometry 4105. FIG. 41c illustrates how the texture map 4110 maps back to the original panorama. Note that the texture of the geometric model (lighter in the foreground) is applied to the image at FIG. 41b, whereas the original image at FIG. 41c does not include such texture information.

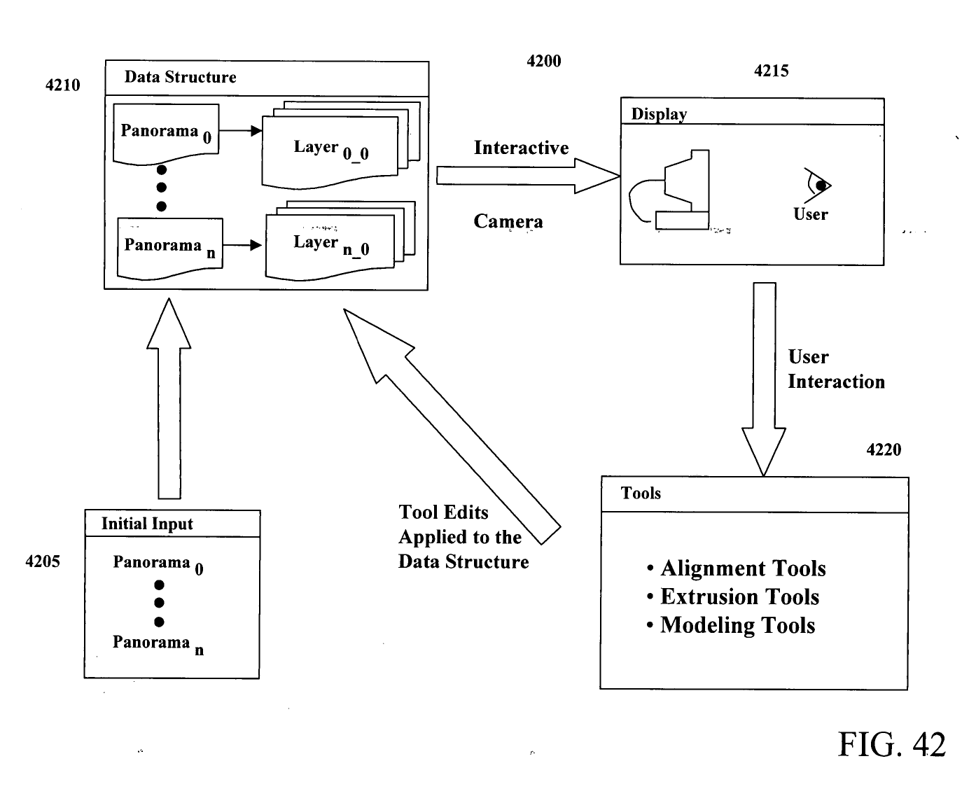

FIG. 42 illustrates the architecture of a system 4200 in accordance with one embodiment of the invention. The architecture includes a device 4205 such as a scanner, a digital camera, or other means for receiving, storing, and/or transferring digital images such one or more image panoramas, two-dimensional images, and three-dimensional images. The image panoramas are stored using a data structure 4210 comprising a set of m layers for each panorama, with each layer comprising color, alpha, and depth channels, as described in commonly-owned U.S. patent application Ser. No. 10/441,972, entitled “Image Based Modeling and Photo Editing,” and incorporated by reference in its entirely herein.

The color channels are used to assign colors to pixels in the image. In a one embodiment, the color channels comprise three individual color channels corresponding to the primary colors red, green and blue, but other color channels could be used. Each pixel in the image has a color represented as a combination of the color channels. The alpha channel is used to represent transparency and object masks. This permits the treatment of semi-transparent objects and fuzzy contours, such as trees or hair. A depth channel is used to assign 3D depth for the pixels in the image.

With the image panoramas stored in the data structure, the image can be viewed using a display 4215. Using the display 4215 and a set of interactive tools 4220, the user interacts with the image causing the edits to be transformed into changes to the data structures. This organization makes it easy to add new functionality. Although the features of the system are presented sequentially, all processes are naturally interleaved. For example, editing can start before depth is acquired, and the representation can be refined while the editing proceeds.

In some embodiments, the functionality of the systems and methods described above can be implemented as software on a general-purpose computer. In such an embodiment, the program can be written in any one of a number of high-level languages, such as FORTRAN, PASCAL, C, C++, C#, LISP, JAVA, or BASIC. Further, the program can be written in a script, macro, or functionality embedded in commercially available software, such as VISUAL BASIC. The program may also be implemented as a plug-in for commercially or otherwise available image editing software, such as ADOBE PHOTOSHOP. Additionally, the software could be implemented in an assembly language directed to a microprocessor resident on a computer. For example, the software could be implemented in Intel 80×86 assembly language if it were configured to run on an IBM PC or PC clone. The software can be embedded on an article of manufacture including, but not limited to, a “computer-readable medium” such as a floppy disk, a hard disk, an optical disk, a magnetic tape, a PROM, an EPROM, or CD-ROM.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes that come within the meaning and range of equivalency of the claims are therefore intended to be embraced.

1. A computerized method for creating a three dimensional model from one or more image panoramas, the method comprising:
receiving one or more image panoramas representing a visual scene and having one or more objects;
determining a directional vector for each image panorama, the directional vector indicating an orientation of the visual scene with respect to a reference coordinate system;
transforming the image panoramas such that the directional vectors are substantially aligned relative to the reference coordinate system;
aligning the transformed image panoramas to each other; and
creating a three dimensional model of the visual scene from the transformed image panoramas using the reference coordinate system and comprising geometry information describing the one or more objects contained in the scene.

2. The method of claim 1 wherein the directional vector is determined based, at least in part, on instructions identifying elements of the image panorama received from a user.

3. The method of claim 2 wherein the instructions from the user identify two or more substantially parallel features in the image.

4. The method of claim 2 wherein the instructions from the user identify two or more sets of substantially parallel features in the image.

5. The method of claim 2 wherein the instructions from the user identifying a horizon line of the image panorama.

6. The method of claim 2 wherein the instructions comprise the identification of two or more areas of the image, each area containing one or more elements and further comprising automatically identifying the two elements contained in the two or more areas.

7. The method of claim 6 further comprising using edge detection to automatically identify the two elements.

8. The method of claim 1 wherein the image panoramas are aligned relative to the reference coordinate system such that the directional vector is at least substantially parallel to one axis of the reference coordinate system.

9. The method of claim 1 wherein the image panoramas are aligned relative to the reference coordinate system such that the directional vector is at least substantially orthogonal to one axis of the reference coordinate system.

10. The method of claim 1 wherein the image panoramas are aligned according to instructions received from a user.

11. A computerized method of interactively editing objects in a panoramic image, the method comprising:
receiving an image panorama representing a visual scene, the image panorama having one or more objects and a point source;
creating a three dimensional model of the visual scene using features of the visual scene and the point source;
receiving an edit to one or more of the objects in the panorama;
transforming the edit relative to a viewpoint defined by the point source; and
projecting the transformed edit onto the objects.

12. The method of claim 11 wherein the three-dimensional model comprises one or more of depth information and geometry information.

13. The method of claim 11, further comprising receiving an edit to color information associated with the objects of the image.

14. The method of claim 11, further comprising receiving an edit to alpha information associated with the objects of the image.

15. The method of claim 11, further comprising receiving an edit to depth information associated with the objects of the image.

16. The method of claim 11, further comprising receiving an edit to geometry information associated with the objects of the image.

17. The method of claim 11 further comprising:
providing a user with an interactive drawing tool that specifies edits for one or more objects of the image; and
receiving the edits made by the user using the interactive drawing tool.

18. The method of claim 17 wherein the interactive drawing tool is one of an extrusion tool, a ground plane tool, a depth chisel tool or a non-uniform rational B-spline tool.

19. The method of claim 17, wherein the interactive drawing tool specifies a selected value for depth for objects of the image.

20. The method of claim 17, wherein the interactive drawing tool incrementally adds to the depth for objects of the image.

21. The method of claim 17, wherein the interactive drawing tool incrementally subtracts from the depth for objects of the image.

22. A method for projecting texture information onto a geometric feature within an image panorama, the method comprising:
receiving instructions from a user identifying a three-dimensional geometric surface within an image panorama, the image panorama containing features having one or more textures;
determining a directional vector from the three-dimensional geometric surface;
creating a geometric model of the image panorama based at least in part on the three-dimensional geometric surface and the directional vector; and
applying the one or more textures to the features in the image panorama based on the geometric model.

23. The method of claim 22 wherein the instructions are received using an interactive drawing tool.

24. The method of claim 22 wherein the three-dimensional geometric surface is one of a floor, a wall, or a ceiling.

25. The method of claim 22 wherein the directional vector is orthogonal to the planar surface.

26. The method of claim 22 wherein the geometric model comprises depth information.

27. The method of claim 22 wherein the texture information comprises color information.

28. The method of claim 22 wherein the texture information comprises luminance information.

29. A computerized method for creating a three-dimensional model of a visual scene from a set of image panoramas, the method comprising:
receiving multiple image panoramas;
arrange each image panorama to a common reference system;
receiving information identifying features common to two or more of the arranged panoramas;
aligning the two or more image panoramas to each other using the identified features; and
creating a three-dimensional model from the aligned image panoramas.

30. The method of claim 29 wherein the instructions are received using an interactive drawing tool.

31. The method of claim 30 wherein the interactive drawing tool is used to identify four or more features common to the two or more image panoramas.

32. A system for creating a three dimensional model from one or more image panoramas, the system comprising:
means for receiving one or more image panoramas representing a visual scene having one or more objects;
means for allowing a user to interact with the system to determine a directional vector for each image panorama;
means for aligning the image panoramas relative to each other; and
means for creating a three dimensional model from the aligned panoramas.

33. The system of claim 32, wherein the input images comprise two-dimensional images.

34. The system of claim 32, wherein the input images comprise three-dimensional images including geometry information.

35. The system of claim 32 wherein the image panoramas are aligned according to instructions received from a user.

36. A system for interactively editing objects in a panoramic image, the system comprising:
a receiver for receiving one or more image panoramas representing a visual scene having one or more objects and a point source;
a modeling module for creating a three dimensional model of the visual scene including depth information describing the objects
one or more interactive editing tools for providing an edit to one or more objects in the panorama;
a transformation module for transforming the edit relative to a viewpoint defined by the point source; and
a rendering module for projecting the transformed edit onto the objects.

37. The system of claim 36 wherein the one or more editing tools comprises a ground plane tool, an extrusion tool, a depth chisel tool, and a non-uniform rational B-spline tool.
